(19) United States
(12) Patent Application Publication
(10) Pub. No.: US 2023/0282232 A1
(43) Pub. Date: Sep. 7, 2023

(54) MAGNETIC RECORDING MEDIUM

(71) Applicant: Sony Group Corporation, Tokyo (JP)

(72) Inventors: Hiroyuki MURAKAMI, Tokyo (JP); Takahiro TAKAYAMA, Tokyo (JP); Takashi AIZAWA, Tokyo (JP); Minoru YAMAGA, Tokyo (JP)

(21) Appl. No.: 18/016,737

(22) PCT Filed: Mar. 11, 2021
(86) PCT No.: PCT/JP2021/009829

§ 371 Date: Jan. 18, 2023

(30) Foreign Application Priority Data
Jul. 21, 2020 (JP) 2020-124509
Nov. 10, 2020 (WO) PCT/JP2020/041804

(51) Int. Cl. G11B 5/706; G11B 5/78; G11B 5/735; G11B 23/107

(52) U.S. Cl. CPC G11B 5/70678; G11B 5/78; G11B 5/7356; G11B 23/107

(57) ABSTRACT

An object of the present invention is to provide a magnetic recording medium capable of suppressing a dimensional change in a width direction by setting the water vapor transmission rate within a specific range.

The present technology provides a magnetic recording medium having a tape shape, the magnetic recording medium including:
a magnetic layer;
a nonmagnetic layer;
a base layer; and
a back layer in this order,
in which the magnetic layer and the nonmagnetic layer are in contact with each other,
the nonmagnetic layer and the base layer are in contact with each other,
an average thickness of the magnetic recording medium is 5.74 μm or less,
a Young's modulus in an MD direction (longitudinal direction) of the base layer is 5.9 GPa or less, and
a water vapor transmission rate of the magnetic recording medium, measured according to a Lyssy method, is 2.93 g/m²·day or less. The Young's modulus in the MD direction of the base layer (longitudinal direction) is 5.3 GPa or less. A humidity expansion coefficient β at a temperature of 10° C. is 6.5 ppm/% RH or less.

### TECHNICAL FIELD

The present technology relates to a magnetic recording medium.

### BACKGROUND ART

In recent years, in a next-generation magnetic tape (magnetic recording medium) requiring a high recording density, securing dimensional stability in the width direction is important from the viewpoint of improving reliability as a product. It is considered that the dimensional stability of the magnetic tape largely depends on the deformation amount of a base film serving as a base material (base layer). The reason why the dimensional stability of the base film largely depends on the deformation amount of the base film is presumed to be due to the environmental factor when the base film is stored.

Several techniques for reducing the dimensional deformation amount have been proposed so far. For example, the magnetic tape medium disclosed in Patent Document 1 below is characterized in that when the Young's modulus in the width direction of a nonmagnetic support is X and the Young's modulus in the width direction of a back layer is Y, X×Y is 6×10⁵ or more in a case where X is 850 kg/mm² or more or less than 850 kg/mm², and when the Young's modulus in the width direction of layers including a magnetic layer is Z, Y/Z is 6.0 or less.

### CITATION LIST

### Patent Document

Patent Document 1: Japanese Patent Application Laid-Open No. 2005-332510

### SUMMARY OF THE INVENTION

### Problems to be Solved by the Invention

A main object of the present technology is to provide a magnetic recording medium capable of suppressing dimensional deformation in a width direction.

### Solutions to Problems

The present technology provides a magnetic recording medium having a tape shape, the magnetic recording medium including:
a magnetic layer;
a nonmagnetic layer;
a base layer; and
a back layer in this order,
in which the magnetic layer and the nonmagnetic layer are in contact with each other,
the nonmagnetic layer and the base layer are in contact with each other,
an average thickness of the magnetic recording medium is 5.74 μm or less,
a Young's modulus in an MD direction (longitudinal direction) of the base layer is 5.9 GPa or less, and
a water vapor transmission rate of the magnetic recording medium, measured according to a Lyssy method, is 2.93 g/m²·day or less.

The water vapor transmission rate can be 2.00 g/m²·day or less.

The water vapor transmission rate can be 1.84 g/m²·day or less.

A water vapor transmission rate of the base layer, measured according to a Lyssy method, can be 7.57 g/m²·day or less.

The water vapor transmission rate of the base layer can be 4.00 g/m²·day or less.

The water vapor transmission rate of the base layer can be 3.00 g/m²·day or less.

The water vapor transmission rate of the base layer can be 2.19 g/m²·day or less.

The Young's modulus in the MD direction (longitudinal direction) of the base layer can be 5.3 GPa or less.

The average thickness of the magnetic recording medium can be 5.60 μm or less.

The average thickness of the magnetic recording medium can be 5.30 μm or less.

A thickness of the nonmagnetic layer can be 1.2 μm or less.

A thickness of the base layer can be 4.5 μm or less.

A thickness of the back layer can be 0.6 μm or less.

A humidity expansion coefficient β at a temperature of 10° C. can be 6.5 ppm/% RH or less.

The magnetic layer can contain magnetic powder.

The magnetic layer and the nonmagnetic layer can be vacuum thin films.

The present technology provides a magnetic recording cartridge in which the magnetic recording medium is accommodated in a case, and the magnetic recording cartridge is wound around a reel.

### BRIEF DESCRIPTION OF DRAWINGS

FIG. 1 is a cross-sectional view illustrating a configuration of a magnetic recording medium according to a first embodiment.

FIG. 2A is a perspective view illustrating a configuration of a measurement apparatus.

FIG. 2B is a schematic view illustrating details of the measurement apparatus.

FIG. 3 is a schematic view illustrating a configuration of a recording and reproducing apparatus.

FIG. 4 is a cross-sectional view illustrating a configuration of a magnetic recording medium in a modification example.

FIG. 5 is a cross-sectional view illustrating a configuration of a magnetic recording medium according to a second embodiment.

FIG. 6 is a schematic view illustrating a configuration of a sputtering apparatus.

FIG. 7 is a cross-sectional view illustrating a configuration of a magnetic recording medium according to a third embodiment.

FIG. 8 is an exploded perspective view illustrating an example of a configuration of a magnetic recording cartridge.

FIG. 9 is a block diagram illustrating an example of a configuration of a cartridge memory.

FIG. 10 is an exploded perspective view illustrating an example of a configuration of modification example of the magnetic recording cartridge.

FIG. 11 is a graph showing a relationship between the humidity expansion coefficient β and the tape water vapor transmission rate at a temperature of 10° C.

FIG. 12 is a graph showing a relationship between the humidity expansion coefficient β and the tape water vapor transmission rate at a temperature of 35° C.

FIG. 13 is a graph showing a relationship between the humidity expansion coefficient β and the tape water vapor transmission rate at a temperature of 60° C.

FIG. 14 is a graph showing a relationship between the temperature expansion coefficient α and the tape water vapor transmission rate at a relative humidity of 10%.

FIG. 15 is a graph showing a relationship between the temperature expansion coefficient α and the tape water vapor transmission rate at a relative humidity of 40%.

FIG. 16 is a graph showing a relationship between the temperature expansion coefficient α and the tape water vapor transmission rate at a relative humidity of 80%.

FIG. 17 is a photograph of the front surface of the sample holder.

FIG. 18 is a photograph of the back surface of the sample holder.

FIG. 19 is a photograph showing a state in which a circular white double-sided sheet WS having six holes is peeled off from the back surface of the sample holder.

FIG. 20 is a photograph showing a state in which samples S are respectively attached to the portion (1), the portion (2), and the portion (3) on the back surface of the sample holder.

FIG. 21 is a photograph of the front surface of a standard sample holder.

FIG. 22 is a photograph of the back surface of the standard sample holder.

FIG. 23 is a printout of input operation parameters.

### MODE FOR CARRYING OUT THE INVENTION

Hereinafter, preferred embodiments for carrying out the present technology will be described. Note that the embodiments described below illustrate representative embodiments of the present technology, and the scope of the present technology is not limited only to these embodiments.

The present technology will be described in the following order.

1. Description of present technology

2. First embodiment (example of application type magnetic recording medium)
(1) Configuration of magnetic recording medium
(2) Description of each layer
(3) Physical properties and structure
(4) Method for producing magnetic recording medium
(5) Recording and reproducing apparatus
(6) Modification examples

3. Second embodiment (example of vacuum thin film type magnetic recording medium)
(1) Configuration of magnetic recording medium
(2) Description of each layer
(3) Physical properties and structure
(4) Configuration of sputtering apparatus
(5) Method for producing magnetic recording medium
(6) Modification examples

4. Third embodiment (example of vacuum thin film type magnetic recording medium)
(1) Configuration of magnetic recording medium
(2) Description of each layer

5. One embodiment of magnetic recording cartridge according to present technology

6. Modification examples of magnetic recording cartridge according to present technology

7. Examples

### 1. Description of Present Technology

It is important to secure the dimensional stability in the width direction in a next-generation magnetic recording tape requiring a high recording density. The dimensional deformation in the width direction of the magnetic recording tape is likely to occur particularly in a case where the magnetic recording tape is stored for a long period of time. The dimensional deformation in the width direction can cause a phenomenon undesirable for magnetic recording, for example, an off-track phenomenon and the like. The off-track phenomenon refers to that there is no target track at a track position to be read by the magnetic head, or that the magnetic head reads at a wrong track position.

The dimensional stability of the magnetic recording tape largely depends on the deformation amount of the base film as a base material, and the environmental factor during storage of the base film is presumed to largely account for the cause of deformation of the base film.

Conventionally, in order to suppress the dimensional deformation of the magnetic recording medium, for example, a method of adding a layer for suppressing dimensional deformation of the magnetic recording medium, or the like has been performed.

The present inventor has found that the parameter indicating the degree of influence of environmental factors on the dimensional stability of the base film constituting the base layer is the humidity expansion coefficient β, and the humidity expansion coefficient β can be reduced, that is, the dimensional stability can be improved by specifying the water vapor transmission rate of the magnetic recording medium within a certain range.

Furthermore, the present inventor has found that the humidity expansion coefficient β can be reduced, that is, the dimensional stability can be improved by specifying the water vapor transmission rate of the base film within a certain range.

That is, in the magnetic recording medium according to the present technology, the water vapor transmission rate measured according to the Lyssy method can be 2.93 g/m²·day or less, preferably 2.00 g/m²·day or less, more preferably 1.84 g/m²·day or less, and still more preferably 1.50 g/m²·day or less. The magnetic recording medium having the water vapor transmission rate within the numerical range described above contributes to suppressing dimensional deformation in the width direction.

Furthermore, the lower limit of the water vapor transmission rate is not particularly limited, but may be, for example, 0 g/m²·day or more, can be preferably 0.2 g/m²·day or more, and more preferably 0.4 g/m²·day or more. The method for measuring the water vapor transmission rate measured according to the Lyssy method will be described in the item (3) of 2 below.

The magnetic recording medium according to the present technology is preferably a long magnetic recording medium, and can be, for example, a magnetic recording tape (particularly, a long magnetic recording tape).

The magnetic recording medium according to the present technology includes a magnetic layer, a nonmagnetic layer, a base layer, and a back layer in this order, and may include other layers in addition to these layers. The magnetic layer and the nonmagnetic layer are in contact with each other, and the nonmagnetic layer and the base layer are in contact with each other. The other layer may be appropriately selected according to the type of the magnetic recording medium. The magnetic recording medium may be, for example, an application type magnetic recording medium or a vacuum thin film type magnetic recording medium. The application type magnetic recording medium will be described in more detail in the item 2. below. The vacuum thin film type magnetic recording medium will be described in more detail in the item 3. below. For layers included in the magnetic recording medium other than the four layers described above, refer to these descriptions.

In the base layer of the magnetic recording medium according to the present technology, the water vapor transmission rate measured according to the Lyssy method can be preferably 7.57 g/m²·day or less, more preferably 4.00 g/m²·day or less, still more preferably 3.00 g/m²·day or less, and still even more preferably 2.19 g/m²·day or less. The lower limit of the water vapor transmission rate of the base layer is not particularly limited, but may be, for example, 0 g/m²·day or more, can be preferably 0.2 g/m²·day or more, and more preferably 0.4 g/m²·day or more. The method for measuring the water vapor transmission rate in the base layer will be described in the item (3) of 2 below.

The Young's modulus in the TD direction (width direction) of the base layer of the magnetic recording medium according to the present technology can be preferably 9.0 GPa or more, more preferably 10.0 GPa or more, and still more preferably 11.0 GPa or more. When the Young's modulus in the TD direction (width direction) of the magnetic recording medium is within the numerical range described above, dimensional deformation in the width direction can be further suppressed. A method for measuring the Young's modulus in the TD direction (width direction) in the base layer will be described in the item (3) of (2) below.

The Young's modulus in the MD direction (longitudinal direction) of the base layer of the magnetic recording medium according to the present technology can be preferably 5.9 GPa or less, and more preferably 5.3 GPa or less. When the Young's modulus in the MD direction (longitudinal direction) of the magnetic recording medium is within the numerical range described above, dimensional deformation can be suppressed. A method for measuring the Young's modulus in the MD direction (longitudinal direction) in the base layer will be described in the item (3) of (2) below.

The average thickness of the magnetic recording medium according to the present technology can be preferably 5.74 μm or less, more preferably 5.60 μm or less, still more preferably 5.30 μm or less, and still more preferably 5.00 μm or less. Since the magnetic recording medium is thin as described above, for example, the length of the tape wound in one magnetic recording cartridge can be made longer, whereby the recording capacity per magnetic recording cartridge can be increased. The lower limit of the average thickness of the magnetic recording medium is not particularly limited, but for example, 3.50 μm≤t_{T}.

The thickness of the nonmagnetic layer of the magnetic recording medium according to the present technology can be preferably 1.2 μm or less, more preferably 1.0 μm or less, and still more preferably 0.8 μm or less. A method for measuring the thickness of the nonmagnetic layer will be described in the item (3) of 2 below.

The thickness of the base layer of the magnetic recording medium according to the present technology can be preferably 4.5 μm or less, more preferably 4.2 μm or less, and still more preferably 3.6 μm or less. A method for measuring the thickness of the base layer will be described in the item (3) of 2 below.

The thickness of the back layer of the magnetic recording medium according to the present technology can be preferably 0.6 μm or less, more preferably 0.5 μm or less, and still more preferably 0.4 μm or less. A method for measuring the thickness of the back layer will be described in the item (3) of 2 below.

The humidity expansion coefficient β at a temperature of 10° C. of the magnetic recording medium according to the present technology can be preferably 6.5 ppm/% RH or less, more preferably 6.0 ppm/% RH or less, and still more preferably 5.5 ppm/% RH or less. The humidity expansion coefficient β is assumed to have a correlation with the water vapor transmission rate described above, and when the humidity expansion coefficient β at a temperature of 10° C. is within a range of 6.5 ppm/% RH or less, the water vapor transmission rate of the magnetic recording medium can be reduced. That is, the dimensional deformation amount can be suppressed. A method for measuring the humidity expansion coefficient β will be described in the item (3) of 2 below.

Furthermore, the humidity expansion coefficient β at a temperature of 35° C. of the magnetic recording medium according to the present technology can be preferably 8.0 ppm/% RH or less, more preferably 7.5 ppm/% RH or less, and still more preferably 7.0 ppm/% RH or less. The humidity expansion coefficient β is assumed to have a correlation with the water vapor transmission rate described above, and when the humidity expansion coefficient β at a temperature of 35° C. is within a range of 8.0 ppm/% RH or less, the water vapor transmission rate of the magnetic recording medium can be reduced. That is, the dimensional deformation amount can be suppressed.

Moreover, the humidity expansion coefficient β at a temperature of 60° C. of the magnetic recording medium according to the present technology can be preferably 11.0 ppm/% RH or less, more preferably 10.0 ppm/% RH or less, and still more preferably 9.0 ppm/% RH or less. The humidity expansion coefficient β is assumed to have a correlation with the water vapor transmission rate described above, and when the humidity expansion coefficient β at a temperature of 60° C. is within a range of 11.0 ppm/% RH or less, the water vapor transmission rate of the magnetic recording medium can be reduced. That is, the dimensional deformation amount can be suppressed.

### 2. First Embodiment (Example of Application Type Magnetic Recording Medium)

### (1) Configuration of Magnetic Recording Medium

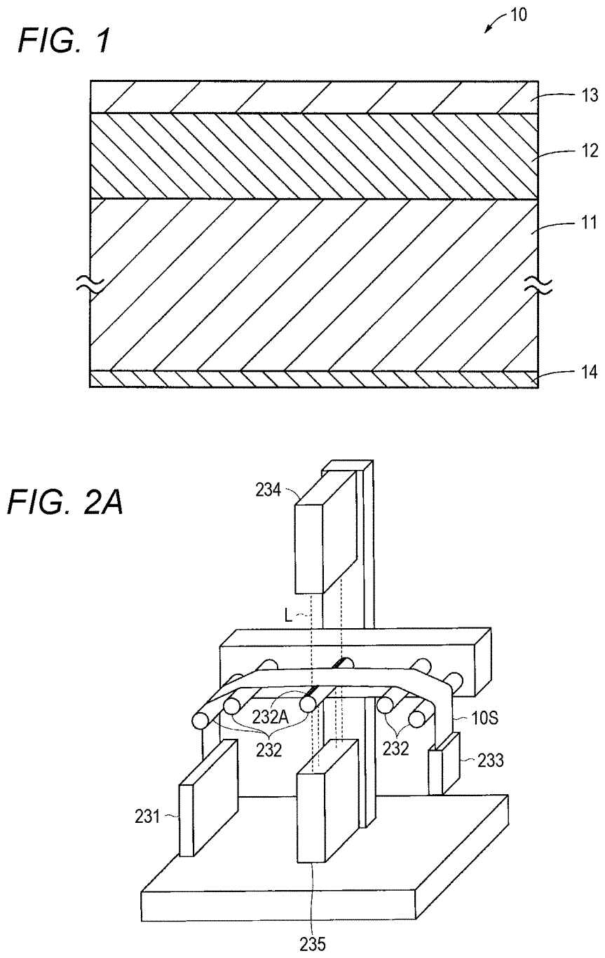

First, the configuration of a magnetic recording medium 10 according to a first embodiment will be described with reference to FIG. 1. The magnetic recording medium 10 is, for example, a magnetic recording medium subjected to perpendicular orientation treatment. The magnetic recording medium 10 includes a long base layer (also referred to as a substrate) 11, an underlayer (nonmagnetic layer) 12 provided on one main surface of the base layer 11, a magnetic layer (also referred to as a recording layer) 13 provided on the underlayer 12, and a back layer 14 provided on the other main surface of the base layer 11 as illustrated in FIG. 1. Hereinafter, of both main surfaces of the magnetic recording medium 10, a surface on a side where the magnetic layer 13 is provided is referred to as a magnetic surface, and a surface opposite to the magnetic surface (a surface on a side where the back layer 14 is provided) is referred to as a back surface.

The magnetic recording medium 10 has a long shape, and travels in the longitudinal direction at the time of recording and reproduction. Furthermore, the magnetic recording medium 10 may be configured to be able to record a signal at the shortest recording wavelength of preferably 100 nm or less, more preferably 75 nm or less, still more preferably 60 nm or less, and particularly preferably 50 nm or less. The magnetic recording medium can be used for, for example, a recording and reproducing apparatus in which the shortest recording wavelength is within the range described above. The recording and reproducing apparatus may include a ring-type head as a recording head. The recording track width is, for example, 2 μm or less.

### (2) Description of Each Layer

(Base Layer)

The base layer 11 can function as a support of the magnetic recording medium 10, and is, for example, a long flexible nonmagnetic substrate, and particularly, can be a nonmagnetic film. The thickness of the base layer 11 can be, for example, preferably 4.5 μm or less, more preferably 4.2 μm or less, and still more preferably 3.6 μm or less. Note that the lower limit of the thickness of the base layer 11 may be determined, for example, from the viewpoint of the limit of film formation, the function of the base layer 11, or the like. The base layer 11 can contain, for example, at least one of a polyester-based resin, a polyolefin-based resin, a cellulose derivative, a vinyl-based resin, an aromatic polyether ketone resin, or other polymer resins. In a case where the base layer 11 contains two or more of the materials described above, the two or more materials may be mixed, copolymerized, or laminated.

The polyester-based resin may be, for example, one or a mixture of two or more of polyethylene terephthalate (PET), polyethylene naphthalate (PEN), polybutylene terephthalate (PBT), polybutylene naphthalate (PBN), polycyclohexylene dimethylene terephthalate (PCT), polyethylene-p-oxybenzoate (PEB), and polyethylene bisphenoxycarboxylate. In accordance with a preferred embodiment of the present technology, the base layer 11 may contain PET or PEN.

The polyolefin-based resin may be, for example, one or a mixture of two or more of polyethylene (PE) and polypropylene (PP).

The cellulose derivative may be, for example, one or a mixture of two or more of cellulose diacetate, cellulose triacetate, cellulose acetate butyrate (CAB), and cellulose acetate propionate (CAP).

The vinyl-based resin may be, for example, one or a mixture of two or more of polyvinyl chloride (PVC) and polyvinylidene chloride (PVDC).

The aromatic polyether ketone resin may be, for example, one or a mixture of two or more of polyether ketone (PEK), polyether ether ketone (PEEK), polyether ketone ketone (PEKK), and polyether ether ketone ketone (PEEKK). In accordance with a preferred embodiment of the present technology, the base layer 11 may contain PEEK.

The other polymer resin may be, for example, one or a mixture of two or more of polyamide (PA, nylon), aromatic polyamide (aromatic PA, aramid), polyimide (PI), aromatic polyimide (aromatic PI), polyamideimide (PAI), aromatic polyamideimide (aromatic PAI), polybenzoxazoles (PBO), for example, ZYLON (registered trademark), polyether, polyether ester, polyether sulfone (PES), polyether imide (PEI), polysulfone (PSF), polyphenylene sulfide (PPS), polycarbonate (PC), polyarylate (PAR), and polyurethane (PU).

(Magnetic Layer)

The magnetic layer 13 can be, for example, a perpendicular recording layer. The magnetic layer 13 can contain magnetic powder. The magnetic layer 13 can further contain, for example, a binder and conductive particles in addition to the magnetic powder. The magnetic layer 13 may further contain, for example, additives such as a lubricant, an abrasive, and a rust inhibitor, as necessary.

The thickness tₘ of the magnetic layer 13 can be preferably 35 nm≤tₘ≤120 nm, more preferably 35 nm≤tₘ≤100 nm, and particularly preferably 35 nm≤tₘ≤90 nm. The thickness tₘ of the magnetic layer 13 within the numerical range described above contributes to improvement of electromagnetic conversion characteristics.

The magnetic layer 13 is preferably a perpendicularly-oriented magnetic layer. In the present specification, the perpendicular orientation means that the squareness ratio S1 measured in the longitudinal direction (traveling direction) of the magnetic recording medium 10 is 35% or less.

Note that the magnetic layer 13 may also be a magnetic layer that is oriented in an in-plane direction (longitudinal orientation). That is, the magnetic recording medium 10 may also be a horizontal recording type magnetic recording medium. However, perpendicular orientation is more preferable in terms of high recording density.

(Magnetic Powder)

Examples of magnetic particles constituting the magnetic powder contained in the magnetic layer 13 can include, but are not limited to, epsilon-type iron oxide (ε iron oxide), gamma hematite, magnetite, chromium dioxide, cobalt-coated iron oxide, hexagonal ferrite, barium ferrite (BaFe), Co ferrite, strontium ferrite, metal, and the like. The magnetic powder may be one of these, or may be a combination of two or more thereof. Particularly preferably, the magnetic powder can contain ε iron oxide magnetic powder, barium ferrite magnetic powder, cobalt ferrite magnetic powder, or strontium ferrite magnetic powder. Note that the ε iron oxide may contain Ga and/or Al. These magnetic particles may be appropriately selected by those skilled in the art on the basis of factors such as, for example, the method for producing the magnetic layer 13, the standard of the tape, and the function of the tape.

The average particle size (average maximum particle size) D of the magnetic powder can be preferably 22 nm or less, more preferably 8 nm or more and 22 nm or less, and still more preferably 10 nm or more and 20 nm or less.

The average particle size D of the magnetic powder described above is obtained as follows. First, the magnetic recording medium 10 to be measured is processed by a focused ion beam (FIB) method or the like to prepare a thin piece, and the cross section of the thin piece is observed with a TEM. Next, 500 ε iron oxide particles are randomly selected from the imaged TEM photograph, the maximum particle size dₘₐₓ of each particle is measured, and the particle size distribution of the maximum particle size dₘₐₓ of the magnetic powder is obtained. Here, the “maximum particle size dₘₐₓ” means a so-called maximum Feret's diameter, and specifically refers to the maximum distance among distances between two parallel lines drawn from all angles so as to be contact with the contour of the ε iron oxide particle. Thereafter, the median diameter (50% diameter, D50) of the maximum particle size dₘₐₓ is obtained from the obtained particle size distribution of the maximum particle size dₘₐₓ, and is taken as the average particle size (average maximum particle size) D of the magnetic powder.

The shape of the magnetic particle depends on the crystal structure of the magnetic particle. For example, BaFe and strontium ferrite can be hexagonal plate-shaped. The ε iron oxide can be spherical. The cobalt ferrite can be cubic. The metal can be spindle-shaped. These magnetic particles are oriented in the production process of the magnetic recording medium 10.

According to a preferred embodiment of the present technology, the magnetic powder can preferably contain powder of nanoparticles containing ε iron oxide (hereinafter, the particles are referred to as “ε iron oxide particles”). The ε iron oxide particles can provide a high coercive force even with fine particles. The crystals of ε iron oxide contained in the ε iron oxide particles are preferably oriented preferentially in the thickness direction (perpendicular direction) of the magnetic recording medium 10.

The ε iron oxide particles have a spherical shape or a substantially spherical shape, or have a cubic shape or a substantially cubic shape. In a case where the ε iron oxide particles are used as the magnetic particles, the contact area between the particles in the thickness direction of the medium is reduced due to the ε iron oxide particles having the shape as described above, and aggregation of the particles can be suppressed, as compared with a case where hexagonal plate-shaped barium ferrite particles are used as the magnetic particles. Therefore, the dispersibility of the magnetic powder can be enhanced, and a better signal-to-noise ratio (SNR) can be obtained.

The ε iron oxide particle has a core-shell type structure. Specifically, the ε iron oxide particle includes a core part, and a shell part having a two-layer structure provided around the core part. The shell part having the two-layer structure includes: a first shell part provided on the core part; and a second shell part provided on the first shell part.

The core part contains ε iron oxide. The ε iron oxide contained in the core part preferably has an ε-Fe₂O₃ crystal as a main phase, and more preferably has a single phase of ε-Fe₂O₃.

The first shell part covers at least a part of the periphery of the core part. Specifically, the first shell part may partially cover the periphery of the core part or may cover the entire periphery of the core part. From the viewpoint of achieving sufficient exchange coupling between the core part and the first shell part and improving magnetic characteristics, it is preferable to cover the entire surface of the core part.

The first shell part is a so-called soft magnetic layer, and can contain, for example, a soft magnetic material such as α-Fe, a Ni—Fe alloy, or a Fe—Si—Al alloy. α-Fe may be obtained by reducing ε iron oxide contained in the core part.

The second shell part is an oxide coating film as an antioxidant layer. The second shell part can contain α-iron oxide, aluminum oxide, or silicon oxide. The α-iron oxide can contain, for example, at least one iron oxide of Fe₃O₄, Fe₂O₃, and FeO. In a case where the first shell part contains α-Fe (soft magnetic material), the α-iron oxide may be obtained by oxidizing α-Fe contained in the first shell part.

The ε iron oxide particle having the first shell part as described above makes it possible to secure thermal stability. This allows the coercive force Hc of the single core part to be maintained at a large value and/or allows the coercive force Hc of the ε iron oxide particle (core-shell type particle) as a whole to be adjusted to a coercive force Hc suitable for recording. Furthermore, the ε iron oxide particles having the second shell part as described above makes it possible to suppress deterioration of the characteristics of the s iron oxide particles due to generation of rust or the like on the particle surface, the rust resulting from exposure of the ε iron oxide particles to the air in the production process of the magnetic recording medium 10 and before the process. Therefore, characteristic deterioration of the magnetic recording medium 10 can be suppressed.

The ε iron oxide particle may have a shell part having a single layer structure. In this case, the shell part has a configuration similar to that of the first shell part. However, from the viewpoint of suppressing characteristic deterioration of the ε iron oxide particles, it is more preferable that the ε iron oxide particles have a shell part having a two-layer structure.

The ε iron oxide particles may contain an additive in place of the core-shell type structure, or may have a core-shell type structure and contain an additive. In these cases, a part of Fe of the ε iron oxide particles is substituted with the additive. Inclusion of the additive in the ε iron oxide particles also allows the coercive force Hc of the entire ε iron oxide particles to be adjusted to a coercive force Hc suitable for recording, thus improving recordability. The additive is a metal element other than iron, preferably a trivalent metal element, more preferably one or more selected from the group consisting of aluminum (Al), gallium (Ga), and indium (In).

Specifically, the ε iron oxide containing an additive is an ε-Fe₂₋ₓMₓO₃ crystal (where M is a metal element other than iron, preferably a trivalent metal element, and more preferably one or more selected from the group consisting of Al, Ga, and In. x is, for example, 0<x<1).

According to another preferred embodiment of the present technology, the magnetic powder may be barium ferrite (BaFe) magnetic powder. The barium ferrite magnetic powder contains iron oxide magnetic particles having barium ferrite as a main phase (hereinafter, the particles are referred to as “barium ferrite particles”). The barium ferrite magnetic powder has high reliability of data recording. For example, the coercivity of the barium ferrite magnetic powder does not decrease even in a high-temperature and high-humidity environment. From such a viewpoint, the barium ferrite magnetic powder is preferable as the magnetic powder.

The average particle size of the barium ferrite magnetic powder is 50 nm or less, more preferably 10 nm or more and 40 nm or less, and still more preferably 12 nm or more and 25 nm or less.

In a case where the magnetic layer 13 contains barium ferrite magnetic powder as the magnetic powder, the thickness tₘ [nm] of the magnetic layer 13 is preferably 35 nm≤tₘ≤120 nm. Furthermore, the coercive force Hc measured in the thickness direction (perpendicular direction) of the magnetic recording medium 10 is preferably 160 kA/m or more and 280 kA/m or less, more preferably 165 kA/m or more and 275 kA/m or less, and still more preferably 170 kA/m or more and 270 kA/m or less.

According to still another preferred embodiment of the present technology, the magnetic powder can be cobalt ferrite magnetic powder. The cobalt ferrite magnetic powder contains iron oxide magnetic particles having cobalt ferrite as a main phase (hereinafter, the particles are referred to as “cobalt ferrite magnetic particles”). The cobalt ferrite magnetic particles preferably have uniaxial anisotropy. The cobalt ferrite magnetic particles have, for example, a cubic shape or a substantially cubic shape. The cobalt ferrite is cobalt ferrite containing Co. The cobalt ferrite may further contain one or more selected from the group consisting of Ni, Mn, Al, Cu, and Zn in addition to Co.

The cobalt ferrite has, for example, an average composition represented by the following formula (1):

CoₓM_{y}Fe₂O_{z} (1)

where M is, for example, one or more metals selected from the group consisting of Ni, Mn, Al, Cu, and Zn, x is a value within a range of 0.4≤x≤1.0, y is a value within a range of 0≤y≤0.3, provided that x and y satisfy the relationship of (x+y)≤1.0, z is a value within a range of 3≤z≤4, and a part of Fe is optionally substituted with another metal element.

The average particle size of the cobalt ferrite magnetic powder is preferably 25 nm or less, and more preferably 23 nm or less. The coercive force Hc of the cobalt ferrite magnetic powder is preferably 2,500 Oe or more, and more preferably 2,600 Oe or more and 3,500 Oe or less.

According to still another preferred embodiment of the present technology, the magnetic powder can contain powder of nanoparticles containing hexagonal ferrite (hereinafter, the nanoparticles are referred to as “hexagonal ferrite particles”). The hexagonal ferrite particles have, for example, a hexagonal plate shape or a substantially hexagonal plate shape. The hexagonal ferrite can preferably contain at least one of Ba, Sr, Pb, or Ca, and more preferably at least one of Ba or Sr. Specifically, the hexagonal ferrite may be, for example, barium ferrite or strontium ferrite. The barium ferrite may further contain at least one of Sr, Pb, or Ca in addition to Ba. The strontium ferrite may further contain at least one of Ba, Pb, or Ca in addition to Sr.

More specifically, the hexagonal ferrite can have an average composition represented by the general formula MFe₁₂O₁₉. Here, M is, for example, at least one metal of Ba, Sr, Pb, and Ca, and preferably at least one metal of Ba and Sr. M may be a combination of Ba and one or more metals selected from the group consisting of Sr, Pb, and Ca. Furthermore, M may be a combination of Sr and one or more metals selected from the group consisting of Ba, Pb, and Ca. In the general formula described above, a part of Fe may be substituted with another metal element.

In a case where the magnetic powder contains powder of hexagonal ferrite particles, the average particle size of the magnetic powder is preferably 50 nm or less, more preferably 10 nm or more and 40 nm or less, and still more preferably 15 nm or more and 30 nm or less.

(Binder)

As the binder, a resin having a structure in which a crosslinking reaction is applied to a polyurethane-based resin, a vinyl chloride-based resin or the like is preferable. However, the binder is not limited to these resins, and other resins may be appropriately blended according to physical properties and the like required for the magnetic recording medium 10. Usually, the resin to be blended is not particularly limited as long as it is a resin generally used in the application type magnetic recording medium 10.

Examples of the binder include polyvinyl chloride, polyvinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, and nitrocellulose), a styrene-butadiene copolymer, a polyester resin, an amino resin, a synthetic rubber, and the like.

Furthermore, a thermosetting resin or a reactive resin may be used as the binder, and examples thereof include a phenol resin, an epoxy resin, a urea resin, a melamine resin, an alkyd resin, a silicone resin, a polyamine resin, a urea formaldehyde resin, and the like.

Furthermore, a polar functional group such as —SO₃M, —OSO₃M, —COOM, or P═O(OM)₂ may be introduced into each binder described above for the purpose of improving the dispersibility of the magnetic powder. Here, in the formula, M is a hydrogen atom or an alkali metal such as lithium, potassium, or sodium.

Moreover, examples of the polar functional group include a side chain type having a terminal group of —NR1R2 or —NR1R2R3⁺X⁻, and a main chain type of >NR1R2⁺X⁻. Here, in the formula, R1, R2, and R3 are a hydrogen atom or a hydrocarbon group, and X⁻ is a halogen element ion such as fluorine, chlorine, bromine, or iodine, or an inorganic or organic ion. Furthermore, examples of the polar functional group include —OH, —SH, —CN, an epoxy group, and the like.

(Additive)

The magnetic layer 13 may further contain, as nonmagnetic reinforcing particles, aluminum oxide (α, β, or γ alumina), chromium oxide, silicon oxide, diamond, garnet, emery, boron nitride, titanium carbide, silicon carbide, titanium carbide, titanium oxide (rutile-type or anatase-type titanium oxide), and the like.

(Underlayer)

The underlayer 12 is a nonmagnetic layer containing nonmagnetic powder and a binder as main components. The description regarding the binder contained in the magnetic layer 13 described above also applies to the binder contained in the underlayer 12. The underlayer 12 may further contain at least one additive selected from conductive particles, a lubricant, a curing agent, a rust inhibitor, and the like as necessary.

The thickness of the underlayer 12 can be preferably 1.2 μm or less, more preferably 1.0 μm or less, and still more preferably 0.8 μm or less. Furthermore, the lower limit of the thickness of the underlayer 12 is not particularly limited, but is preferably 0.2 μm or more, and more preferably 0.4 μm or more.

(Nonmagnetic Powder)

The nonmagnetic powder contained in the underlayer 12 can contain, for example, at least one selected from inorganic particles and organic particles. One nonmagnetic powder may be used alone, or two or more nonmagnetic powders may be used in combination. The inorganic particles contain, for example, one or a combination of two or more selected from a metal, a metal oxide, a metal carbonate, a metal sulfate, a metal nitride, a metal carbide, and a metal sulfide. More specifically, the inorganic particles can be, for example, one or two or more selected from iron oxyhydroxide, hematite, titanium oxide, and carbon black. Examples of the shape of the nonmagnetic powder include various shapes such as a needle shape, a spherical shape, a cubic shape, and a plate shape, but are not particularly limited thereto.

(Back Layer)

The back layer 14 can contain a binder and nonmagnetic powder. The back layer 14 may contain various additives such as a lubricant, a curing agent, and an antistatic agent as necessary. The description of the binder and the nonmagnetic powder contained in the underlayer 12 described above also applies to the binder and the nonmagnetic powder contained in the back layer 14.

The average particle size of the inorganic particles contained in the back layer 14 is preferably 10 nm or more and 150 nm or less, and more preferably 15 nm or more and 110 nm or less. The average particle size of the inorganic particles is obtained in a manner similar to the average particle size D of the magnetic powder described above.

The thickness t_{b} of the back layer 14 is preferably t_{b}≤0.6 μm. Even in a case where the thickness t_{T} of the magnetic recording medium 10 is t_{T}≤5.6 μm, the back layer 14 having the thickness t_{b} within the range described above allows the thicknesses of the underlayer 12 and the base layer 11 to be kept thick. This allows the traveling stability of the magnetic recording medium in the recording and reproducing apparatus to be maintained.

### (3) Physical Properties and Structure

(Water Vapor Transmission Rate of Magnetic Recording Medium)

The water vapor transmission rate is an index representing the amount of water vapor transmitted through a film base material of 1 m² in 24 hours in the number of grams. The unit is expressed in g/m²·day. In other words, the water vapor transmission rate can be used as an index indicating water vapor barrier properties. A lower numerical value indicates lower water vapor transmission rate and means higher water vapor barrier properties.

In the magnetic recording medium according to the present technology, the water vapor transmission rate means an index measured according to the Lyssy method. The Lyssy method is also referred to as a moisture sensor method.

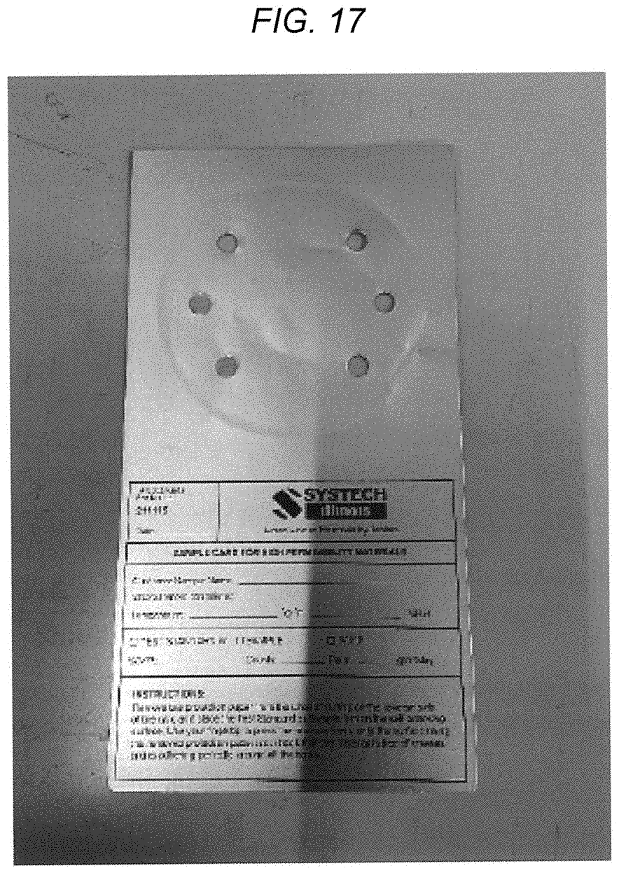

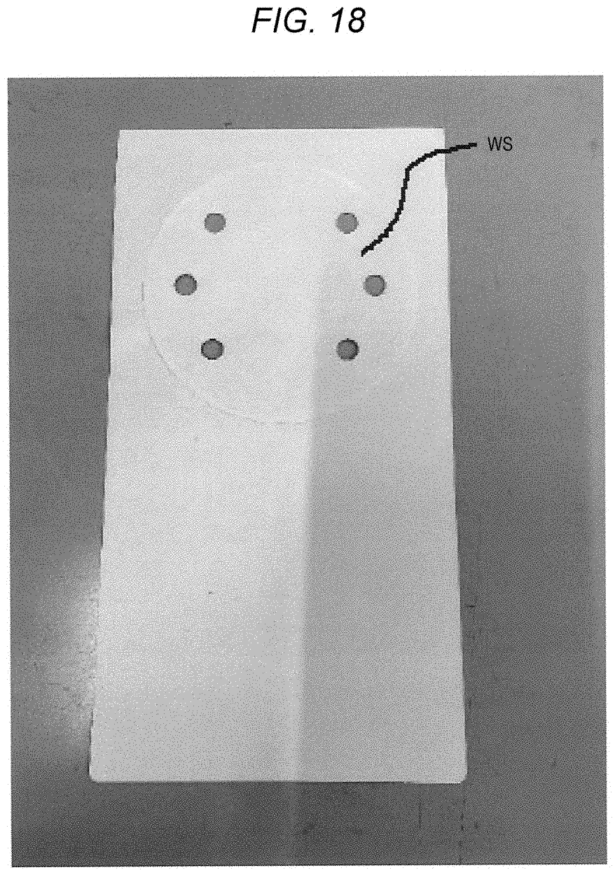

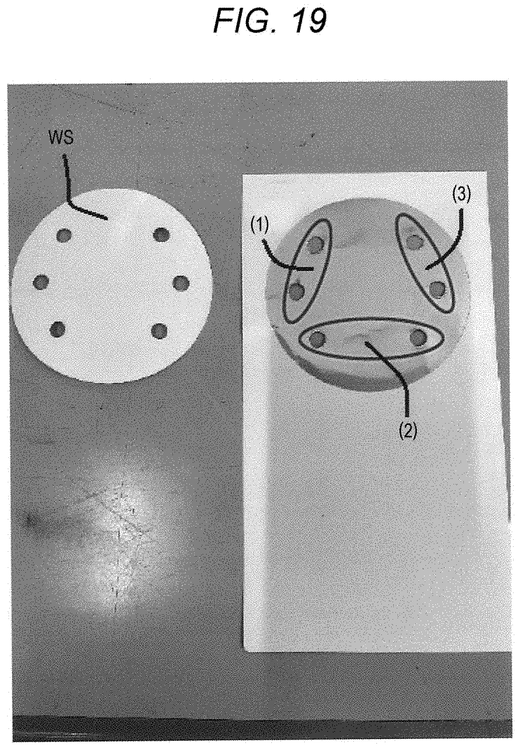

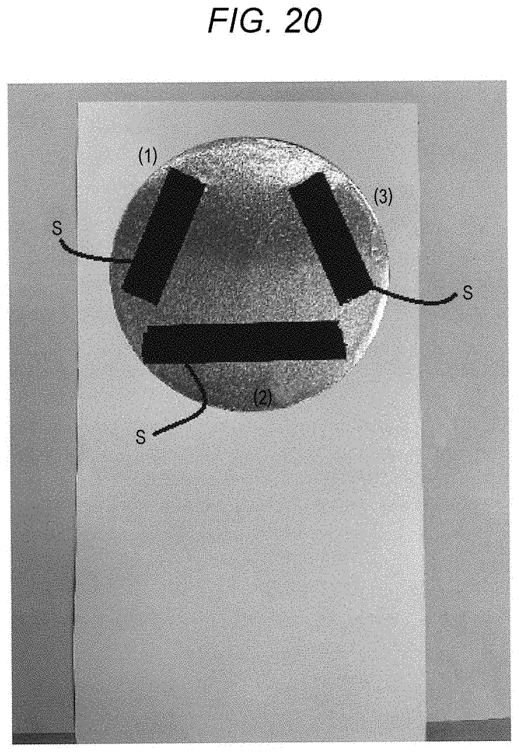

In the present technology, in the measurement of the water vapor transmission rate, first, a sample holder (manufactured by SYSTECH) illustrated in FIGS. 17 and 18 is prepared. FIG. 17 is a photograph of the front surface of the sample holder. FIG. 18 is a photograph of the back surface of the sample holder. As illustrated in FIG. 18, a white double-sided sheet including a circular white double-sided sheet WS having six holes, and a portion other than the circular white double-sided sheet is bonded to the back surface of the sample holder. FIG. 19 is a photograph showing a state in which the circular white double-sided sheet WS having six holes is peeled off from the back surface of the sample holder illustrated in FIG. 18. First, as illustrated in FIG. 19, the circular white double-sided sheet WS having six holes on the back surface of the sample holder is peeled off from the back surface of the sample holter. Next, since the variation in numerical value of the water vapor transmission rate in the longitudinal direction of the magnetic recording medium 10 is considered to be small, the magnetic recording medium 10 is cut at any position in the longitudinal direction of the magnetic recording medium 10 with a width of 12.65 mm, to cut out a test piece with a length of 14 cm. The cut test piece is attached to a dust-free paper. In the test piece attached to the dust-free paper, marks are made at an interval of 4 cm, an interval of 6 cm, and an interval of 4 cm, respectively. A piece of mending tape is attached to each of a portion having an interval of 4 cm, a portion having an interval of 6 cm, and a portion having an interval of 4 cm of the test piece. A sample having a length of 4 cm, a sample having a length of 6 cm, and a sample having a length of 4 cm are cut out, with a cutter, from the test piece to which the mending tape has been attached. Next, the cut sample having a length of 4 cm is carefully attached to the portion (1) on the back surface of the sample holder with the magnetic layer surface facing downward so that two holes are completely covered. After attaching, the mending tape is cut to an appropriate length. The remaining mending tape is cut off. Subsequently, the sample having a length of 6 cm is carefully attached to the portion (2) on the back surface of the sample holder with the magnetic layer surface facing downward so that two holes are completely covered. After attaching, the mending tape is cut to an appropriate length. The remaining mending tape is cut off. Subsequently, the remaining sample having a length of 4 cm is carefully attached to the portion (3) on the back surface of the sample holder with the magnetic layer surface facing downward so that two holes are completely covered. After attaching, the mending tape is cut to an appropriate length. The remaining mending tape is cut off. FIG. 20 is a photograph showing a state in which samples S are respectively attached to the portion (1), the portion (2), and the portion (3) on the back surface of the sample holder. As illustrated in FIG. 20, six holes of the sample holder are completely covered by the samples S. Thereafter, the peeled circular white double-sided sheet WS having six holes is attached to the back surface of the sample holder. Note that, when the circular white double-sided sheet WS is attached to the back surface of the sample holder, the circular white double-sided sheet WS is attached to the sample holder so that the positions of the holes of the circular white double-sided sheet WS are aligned with the concave holes of the samples S respectively attached to the portion (1), the portion (2), and the portion (3) of the back surface of the sample holder.

In the present technology, the water vapor transmission rate is measured by the following procedure. A measurement apparatus is used that includes: a transmission cell having two chambers on a low-humidity side and a high-humidity side above and below a test piece; a moisture sensor on a side of the low-humidity chamber, the moisture sensor detecting the amount of water vapor that has been transmitted as relative humidity; a pump for supplying dry air; a drying cylinder; and the like. Examples of such a measurement apparatus include an L80-5000 type water vapor transmission rate meter manufactured by Lyssy. In the measurement of the water vapor transmission rate, test water is stored in the high-humidity chamber of the transmission cell. The low-humidity chamber has a structure capable of accumulating water vapor that has been transmitted through the test piece from the high-humidity side, and the moisture sensor is installed above the low-humidity chamber. The transmission cell is a mechanism that is kept within a predetermined range of the test temperature by a temperature controller. After the main power of the apparatus is turned on, the apparatus waits for 1 to 3 hours until the measured temperature is stabilized, and the measurement is performed after the measured temperature is stabilized. Note that, in a case where the apparatus is left standing in an environment maintained at a temperature of 25° C. and a humidity of 50 to 60%, the measured temperature is considered to be stable, and the measurement can be performed immediately after the main power is turned on. The measurement of the water vapor transmission rate is automatically controlled by the apparatus, for example, and is performed by the following procedure.

1. The low-humidity chamber on the upper side of the test piece is previously dried to a predetermined level, and the valve is closed.

2. The low-humidity chamber is humidified to a predetermined level by water vapor transmission through the test piece.

3. The increase in relative humidity is measured, and the time required for the relative humidity to change by a difference between small relative humidity values set in two stages is measured.

A specific operation procedure is as follows. Note that the water vapor transmission rate meter (model L80-5000, manufactured by Lyssy) is left standing in a room maintained at a temperature of 25° C. and a humidity of 50 to 60%.

(1) The main switch of the power supply of the water vapor transmission rate meter (model L80-5000, manufactured by Lyssy) is turned on, and the switch of the front part of the apparatus is turned on.

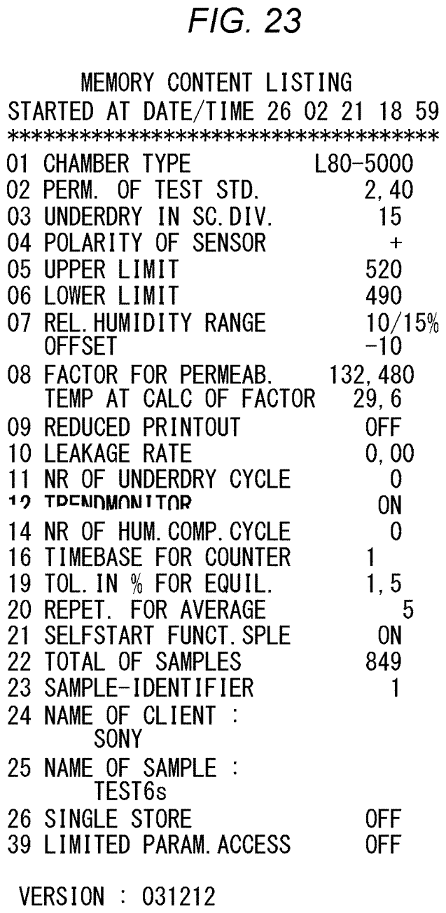

(2) After starting the apparatus, the apparatus is allowed to stand, and after about 30 minutes, pure water is put into a water receiver of the apparatus. The operating parameters are input into the memory of the apparatus. Specifically, the MEMO key is pressed to enter the memory input mode, and the SET key is pressed to input respective operation parameters. FIG. 23 is a printout of the input operation parameters. The parameters used in FIG. 23 are as follows:
Parameter 02: transmittance of standard sample
Parameter 03: UnderDry scale
Parameter 04: attributes of the measurement (normal +)
Parameter 05: Upper limit
Parameter 06: Lower limit
Parameter 07: Relative humidity range
Parameter 08: Transmittance factor and temperature at the time of calibration
Parameter 09: Brief printout of parameters (ON or OFF)
Parameter 10: Leakage amount of instrument
Parameter 11: Number of times of UNDERDRY CYCLES
Parameter 12: TRENDMONITOR (ON or OFF)
Parameter 14: Number of times of HUMIDITY COMP.CYCLES
Parameter 16: Counter time base
Parameter 19: Equilibrium tolerance
Parameter 20: Number of iterations of average calculation
Parameter 21: SAMPLE function automatic start
Parameter 22: Total number of measurements
Parameter 23: Sample identification name (for RS232C)
Parameter 24: Client name
Parameter 25: Sample name
Parameter 30: Temperature

(3) The needle valve on the bottom plate of the silica gel cartridge is turned counterclockwise 1 or 2 times, and next, the opening valve is adjusted to adjust the flow rate of the dry air for chamber purging so that the drying speed is 1 to 2 scale/sec. In order to obtain a result with good reproducibility, adjustment is performed several times until a correct value is obtained in the UNDER DRY cycle. The flow rate of the dry air is adjusted by the level of the transmittance of the sample. When the sample of the new series is first measured, the flow rate is reduced so that the overshoot of UNDERDRY is minimized.

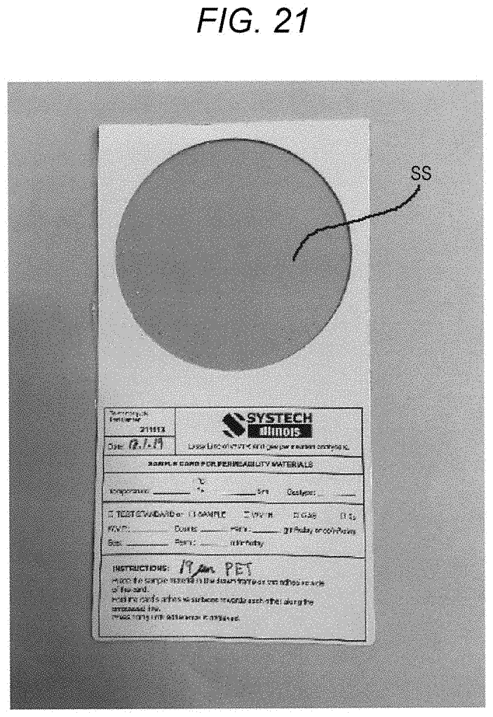

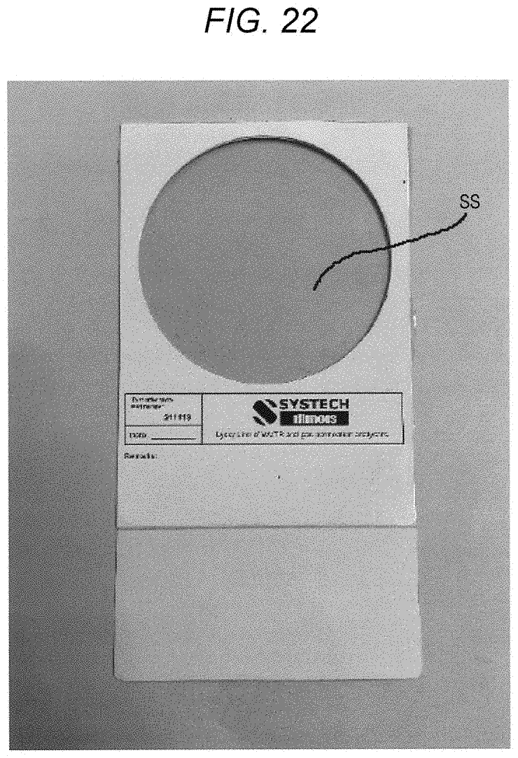

(4) As a standard sample, 19 μm PET (model number: 211113, manufactured by SYSTECH) is used. FIG. 21 is a photograph of the front surface of a standard sample holder. FIG. 22 is a photograph of the back surface of the standard sample holder. In FIGS. 21 and 22, a standard sample S (19 μm PET) is placed in a circular opening. The measurement chamber is opened by rotating the hand wheel counterclockwise, the standard sample holder shown in FIGS. 21 and 22 is accommodated in the apparatus, and the measurement chamber is closed by rotating the hand wheel clockwise.

(5) Eight hours after the start-up of the apparatus, the TEST STD key on the alphanumeric keyboard is pressed to start calibration. Since the operation parameter 21 is set to ON as illustrated in FIG. 23, when the equilibrium is reached, the apparatus automatically ends calibration and starts the measurement using the standard sample as a sample. Note that the measurement temperature is 25° C., and the measurement humidity is 50%.

(6) In a case where the average deviation of the measured values at five consecutive points falls within 3.8%, the average value at the five points is used as the measured value, and the STOP key is pressed to end the measurement. Note that the number of measurements is about 10.

(7) The standard sample is removed from the apparatus.

(8) The hand wheel is rotated counterclockwise to open the measurement chamber, and the sample holder shown in FIGS. 17 and 18 is accommodated in the apparatus.

(9) The currently executed measurement or data input is ended by the STOP key. The MEMO key is pressed and the currently set operating parameters are sequentially checked to confirm that the operating parameters of MEMO are compatible with the measurement sample. The new sample name is input and the SAMPLE key is pressed to start measurement.

(10) In a case where the average deviation of the measured values at five consecutive points falls within 3.8%, the average value at the five points is used as the measured value, and the STOP key is pressed to end the measurement. Note that the number of measurements is about 10.

(11) The measurement sample is removed from the apparatus.

(12) A dummy sample holder is placed in the apparatus.

(13) The switch of the front part of the apparatus is turned off, and the main switch of the power supply of the water vapor transmission rate meter (model L80-5000, manufactured by Lyssy) is turned off.

Regarding the water vapor transmission rate of the base layer 11, first, the underlayer 12, the magnetic layer 13, and the back layer 14 are removed from the magnetic recording medium 10 to obtain the base layer 11. Using this base layer 11, the water vapor transmission rate can be obtained by the method for measuring the water vapor transmission rate described in the method for measuring the water vapor transmission rate of the magnetic recording medium 10.

(Young's Modulus of Magnetic Recording Medium)

The Young's moduli in the width direction (TD direction) and the longitudinal direction (MD direction) of the magnetic recording medium 10 are measured using a tensile tester (AG-100D, manufactured by Shimadzu Corporation). First, a magnetic recording medium 10 having a width of ½ inches is cut into a length of 180 mm to prepare a measurement sample. Two jigs capable of fixing the measurement sample so as to cover the entire width thereof are attached to the tensile tester described above. Two ends in the width direction of the measurement sample are chucked by the two jigs. The distance between chucks is 100 mm. After chucking the measurement sample, stress is gradually applied so as to pull the measurement sample in the width direction. The pulling speed is 0.1 mm/min. From the change in stress and the amount of elongation at this time, the Young's modulus is calculated using the following equation.

E={(ΔN/S)/(Δx/L)}×10⁶ [Mathematical Formula 1]

In the equation described above, E represents the Young's modulus (N/m²), ΔN represents the change in stress (N), S represents the cross-sectional area (mm²) of the measurement sample, Δx represents the amount of elongation (mm), and L represents the distance between two jigs (distance between chucks) (mm).

The stress when the measurement sample is pulled by the tensile tester described above is changed from 0.5 N to 1.0 N. The change in stress (ΔN) and the amount of elongation (Δx) when the stress is changed in this manner are used for the calculation according to the equation described above.

(Young's Modulus of Base Layer)

The Young's moduli in the TD (width direction) and MD (longitudinal direction) of the base layer 11 described above are obtained as follows. First, the underlayer 12, the magnetic layer 13, and the back layer 14 are removed from the magnetic tape 10 to obtain the base layer 11. The Young's moduli in the TD (width direction) and MD (longitudinal direction) are obtained using the base layer 11.

(Thickness t_{T} of Magnetic Recording Medium)

The thickness t_{T} of the magnetic recording medium is obtained as follows. First, a magnetic recording medium 10 having a width of ½ inches is prepared, and cut into a length of 250 mm to prepare a sample. Next, the thickness of the sample is measured at five or more different points using a laser hologauge manufactured by Mitutoyo Corporation as a measurement apparatus, and the measured values are simply averaged (arithmetically averaged) to calculate an average value t_{T} [μm].

(Thickness of Nonmagnetic Layer)

The magnetic recording medium 10 is thinly processed perpendicularly with respect to the main surface thereof to prepare a test piece, and the cross section of the test piece is observed with a transmission electron microscope (TEM) under the following conditions.

Apparatus: TEM (H9000NAR, manufactured by Hitachi, Ltd.)

Acceleration voltage: 300 kV

Magnification: 100,000 times

Next, using the obtained TEM image, the thickness of the nonmagnetic layer (underlayer) 12 is measured at positions of at least ten or more points in the longitudinal direction of the magnetic recording medium 10, and then, the measured values are simply averaged (arithmetically averaged) to determine the thickness (μm) of the nonmagnetic layer (underlayer) 12.

(Thickness of Base Layer)

The thickness of the base layer 11 can be obtained as follows. First, a magnetic recording medium 10 having a width of a ½ inch is prepared, and cut into a length of 250 mm to prepare a sample. Subsequently, layers other than the base layer 11 of the sample are removed with, for example, a solvent such as methyl ethyl ketone (MEK), or dilute hydrochloric acid or the like. Next, the thickness of the sample (base layer 11) is measured at positions of five or more points using a laser hologauge manufactured by Mitutoyo Corporation as a measurement apparatus, and the measured values are simply averaged (arithmetically averaged) to determine the thickness [μm] of the base layer 11.

(Thickness of Back Layer)

The thickness t_{b} of the back layer 14 is obtained as follows. First, a magnetic recording medium 10 having a width of ½ inches is prepared, and cut into a length of 250 mm to prepare a sample. Next, the thickness of the sample is measured at five or more different points using a laser hologauge manufactured by Mitutoyo Corporation as a measurement apparatus, and the measured values are simply averaged (arithmetically averaged) to calculate an average value t_{T} [μm]. Subsequently, the back layer 14 of the sample is removed with a solvent such as methyl ethyl ketone (MEK), dilute hydrochloric acid, or the like, the thickness of the sample is measured at five or more different points again using the laser hologauge described above, and the measured values are simply averaged (arithmetically averaged) to calculate an average value t_{B} [μm]. Thereafter, the thickness t_{b} [μm] of the back layer 14 is obtained by the following equation.

t_{b} [μm]=t_{T} [μm]−t_{B} [μm]

(Thickness tₘ of Magnetic Layer)

The thickness tₘ of the magnetic layer 13 is obtained as follows. First, the magnetic recording medium 10 is thinly processed perpendicularly with respect to the main surface thereof to prepare a test piece, and the cross section of the test piece is observed with a transmission electron microscope (TEM) under the following conditions.

Apparatus: TEM (H9000NAR, manufactured by Hitachi, Ltd.)

Acceleration voltage: 300 kV

Magnification: 100,000 times

Next, the thickness of the magnetic layer 13 is measured at positions of at least ten or more points in the longitudinal direction of the magnetic recording medium 10 using the obtained TEM image, and then the measured values are simply averaged (arithmetically averaged) to determine the thickness tₘ (nm) of the magnetic layer 13.

(Humidity Expansion Coefficient β)

First, a magnetic recording medium 10 having a width of ½ inches is prepared, and cut into a length of 250 mm to prepare a sample 10S.

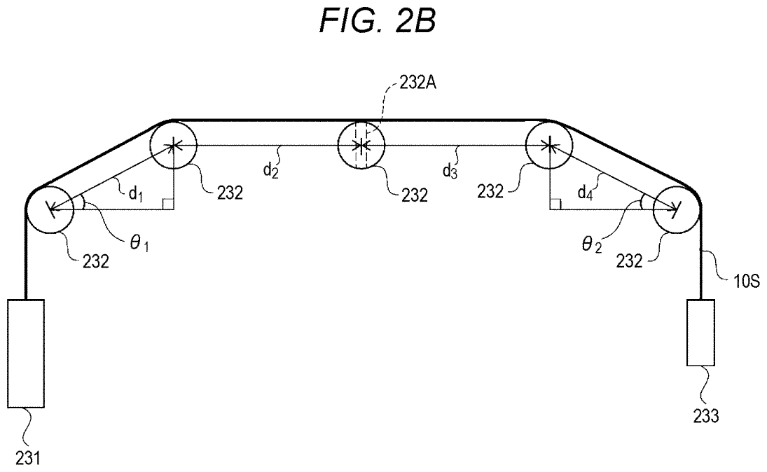

As a measurement apparatus, the measurement apparatus illustrated in FIG. 2A, the measurement apparatus into which a digital dimension measurement instrument LS-7000 manufactured by Keyence Corporation is incorporated is prepared, and the sample 10S is set in the measurement apparatus. Specifically, one end of the long sample (magnetic recording medium) 10S is fixed by a fixing part 231. Next, as illustrated in FIG. 2A, the sample 10S is set on five substantially cylindrical and rod-shaped support members 232. The sample 10S is set on the five support members 232 such that the back surface of the sample 10S is in contact with these support members. The five support members 232 (particularly, surfaces thereof) all contain stainless steel SUS 304, and have a surface roughness R_{Z} (maximum height) of 0.15 μm to 0.3 μm.

The disposition of the five rod-shaped support members 232 will be described with reference to FIG. 2B. As illustrated in FIG. 2B, the sample 10S is set on the five support members 232. Hereinafter, the five support members 232 will be referred to as a “first support member”, a “second support member”, a “third support member” (having a slit 232A), a “fourth support member”, and a “fifth support member” (closest to a weight 233) from the side closest to the fixing part 231. The diameters of the five support members are 7 mm. A distance d₁ between the first support member and the second support member (particularly, a distance between the centers of these support members) is 20 mm. A distance d₂ between the second support member and the third support member is 30 mm. A distance d₃ between the third support member and the fourth support member is 30 mm. A distance d₄ between the fourth support member and the fifth support member is 20 mm. Furthermore, these three support members are disposed such that a portion of the sample 10S set between the second support member, the third support member, and the fourth support member forms a plane substantially perpendicular to the direction of gravity. Furthermore, the first support member and the second support member are disposed such that the sample 10S forms an angle of θ₁=30° with respect to the substantially perpendicular plane between the first support member and the second support member. Moreover, the fourth support member and the fifth support member are disposed such that the sample 10S forms an angle of θ₂=30° with respect to the substantially perpendicular plane between the fourth support member and the fifth support member.

Furthermore, among the five support members 232, the third support member is fixed so as not to rotate, but all the other four support members are rotatable.

The sample 10S is held on the support members 232 so as not to move in the width direction of the sample 10S. Note that, among the support members 232, the slit 232A is provided in the support member 232 located between a light emitter 234 and a light receiver 235 and located substantially at the center between the fixing part 231 and the portion to which the load is applied. Light L is emitted from the light emitter 234 to the light receiver 235 through the slit 232A. The slit width of the slit 232A is 1 mm, and the light L can pass through the width without being blocked by the frame of the slit 232A.

The measurement apparatus is accommodated in a chamber controlled to a constant environment of a temperature of 10° C. and a relative humidity of 40%. Next, a load is applied in the longitudinal direction of the sample 10S, and the sample 10S is placed in the environment described above for 6 hours. Thereafter, the relative humidity is changed in the order of 80%, 40%, and 10% while the temperature is maintained at 10° C., the widths of the sample 10S at 80%, 40%, and 10% are measured, and the humidity expansion coefficient β is obtained from the following equation. The measurement at these humidities is performed immediately after each humidity is reached. Note that the measurement at a humidity of 40% is performed to confirm whether or not abnormality has occurred in the measurement, and the measurement result thereof is not used in the following equation Note that, in the case of the temperature of 35° C. and the case of the temperature of 60° C., the humidity expansion coefficient β is obtained under the same conditions as in the case of the measurement at the temperature of 10° C. except for the temperature conditions.

$$β [ ppm / \% RH ] = \frac{D ( 80 \% ) [ mm ] - D ( 10 \% ) [ mm ]}{D ( 10 \% ) [ mm ]} \times \frac{1 , 000 , 000}{( 80 [ \% ] - ( 10 [ \% ] )} \qquad [ Mathematical Formula 2 ]$$

where D (80%) and D (10%) represent the widths of the sample 10S at relative humidities of 80% and 10%, respectively.

(Temperature Expansion Coefficient α)

The temperature expansion coefficient α is obtained as follows. First, the sample 10S is prepared in a manner similar to the method for measuring the humidity expansion coefficient β, the sample 10S is set in an apparatus similar to the method for measuring the humidity expansion coefficient β, and then, the measurement apparatus is accommodated in a chamber controlled to a constant environment of a temperature of 35° C. and a relative humidity of 10%. Next, a load is applied in the longitudinal direction of the sample 10S, and the sample 10S is placed in the environment described above for 6 hours. Thereafter, the temperature is changed in the order of 60° C., 35° C., and 10° C. while the relative humidity of 10% is maintained, the widths of the sample 10S at 60° C., 35° C., and 10° C. are measured, and the temperature expansion coefficient α is obtained from the following equation. The measurement at these temperatures is performed 2 hours after each temperature is reached. Note that the measurement at a temperature of 35° C. is performed to confirm whether or not abnormality has occurred in the measurement, and the measurement result thereof is not used in the following equation. Note that, in the case of the relative humidity of 40% and the case of the relative humidity of 80%, the temperature expansion coefficient α is obtained under the same conditions as in the case of measurement at the relative humidity of 10% except for the relative humidity conditions.

$$α [ ppm / ° C . ] = \frac{D [ 60 ° C . [ mm ] - D ( 10 ° C . ) [ mm ]}{D ( 10 ° C . ) [ mm ]} \times \frac{1 , 000 , 000}{( 60 [ ° C . ] ) - ( 10 [ ° C . ] )} \qquad [ Mathematical Formula 3 ]$$

where D (60° C.) and D (10° C.) represent the widths of the sample 10S at temperatures of 60° C. and 10° C., respectively.

### (4) Method for Producing Magnetic Recording Medium

Next, a method for producing the magnetic recording medium 10 having the configuration described above will be described. First, a coating material for forming a nonmagnetic layer (underlayer) is prepared by kneading and/or dispersing nonmagnetic powder, a binder, and the like in a solvent. Next, a coating material for forming a magnetic layer is prepared by kneading and/or dispersing magnetic powder, a binder, and the like in a solvent. For the preparation of the coating material for forming a magnetic layer and the coating material for forming a nonmagnetic layer (underlayer), for example, the following solvents, dispersing apparatuses, and kneading apparatuses can be used.

Examples of the solvent used for preparing the coating material described above include ketone-based solvents such as acetone, methyl ethyl ketone, methyl isobutyl ketone, and cyclohexanone; alcohol-based solvents such as methanol, ethanol, and propanol; ester-based solvents such as methyl acetate, ethyl acetate, butyl acetate, propyl acetate, ethyl lactate, and ethylene glycol acetate; ether-based solvents such as diethylene glycol dimethyl ether, 2-ethoxyethanol, tetrahydrofuran, and dioxane; aromatic hydrocarbon-based solvents such as benzene, toluene, and xylene; and halogenated hydrocarbon-based solvents such as methylene chloride, ethylene chloride, carbon tetrachloride, chloroform, and chlorobenzene. One of these may be used, or a mixture of two or more thereof may be used.

As the kneading apparatus used for preparing the coating material described above, for example, kneading apparatuses such as a continuous twin-screw kneader, a continuous twin-screw kneader capable of diluting in multiple stages, a kneader, a pressure kneader, and a roll kneader can be used, but the kneading apparatus is not particularly limited to these apparatuses. Furthermore, as the dispersing apparatus used for preparing the coating material described above, for example, dispersing apparatuses such as a roll mill, a ball mill, a horizontal sand mill, a vertical sand mill, a spike mill, a pin mill, a tower mill, a pearl mill (for example, “DCP mill” manufactured by Maschinenfabrik Gustav Eirich GmbH & Co KG), a homogenizer, and an ultrasonic dispersing machine can be used, but the dispersing apparatus is not particularly limited to these apparatuses.

Next, the coating material for forming a nonmagnetic layer (underlayer) is applied to one main surface of the base layer 11 and dried to form the underlayer 12. Subsequently, the coating material for forming a magnetic layer is applied onto the underlayer 12 and dried to form the magnetic layer 13 on the underlayer 12. Note that, at the time of drying, the magnetic powder is magnetically oriented in the thickness direction of the base layer 11 by, for example, a solenoid coil. Furthermore, at the time of drying, for example, the magnetic powder may be subjected to magnetic orientation in the longitudinal direction (traveling direction) of the base layer 11 by a solenoid coil, and then subjected to magnetic orientation in the thickness direction of the base layer 11. By performing such a magnetic orientation treatment, the ratio Hc2/Hc1 of a holding force “Hc1” in the perpendicular direction to a holding force “Hc2” in the longitudinal direction can be reduced, so that the degree of perpendicular orientation of the magnetic powder can be improved. After the magnetic layer 13 is formed, the back layer 14 is formed on the other main surface of the base layer 11. As a result, the magnetic recording medium 10 is obtained.

The ratio Hc2/Hc1 is set to a desired value, for example, by adjusting the intensity of the magnetic field to be applied to the coating film of the coating material for forming a magnetic layer, the concentration of the solid content in the coating material for forming a magnetic layer, and the drying conditions (drying temperature and drying time) of the coating film of the coating material for forming a magnetic layer. The intensity of the magnetic field to be applied to the coating film is preferably 2 times or more and 3 times or less the holding force of the magnetic powder. In order to further increase the ratio Hc2/Hc1, it is also preferable to magnetize the magnetic powder at a stage before the coating material for forming a magnetic layer is introduced into the orientation apparatus for subjecting the magnetic powder to magnetic orientation. Note that the method for adjusting the ratio Hc2/Hc1 may be used alone or in combination of two or more.

Thereafter, the obtained magnetic recording medium is rewound around a large-diameter core, and a curing treatment is performed. Finally, the magnetic recording medium 10 is subjected to a calender treatment and then cut into a predetermined width (for example, ½ inch width). As described above, the target thin long magnetic recording medium 10 is obtained.

### (5) Recording and Reproducing Apparatus

[Configuration of Recording and Reproducing Apparatus]

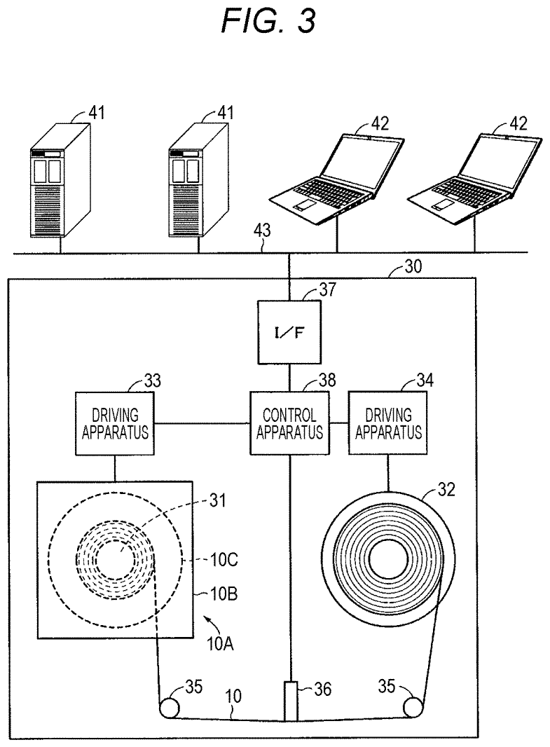

Next, an example of the configuration of a recording and reproducing apparatus 30 that performs recording and reproduction of the magnetic recording medium 10 having the configuration described above will be described with reference to FIG. 3.

The recording and reproducing apparatus 30 has a configuration capable of adjusting tension applied in the longitudinal direction of the magnetic recording medium 10. Furthermore, the recording and reproducing apparatus has a configuration capable of loading a magnetic recording cartridge 10A. Here, in order to facilitate the description, a case where the recording and reproducing apparatus 30 has a configuration capable of loading one magnetic recording cartridge 10A will be described. However, the recording and reproducing apparatus 30 may have a configuration capable of loading a plurality of magnetic recording cartridges 10A.

The recording and reproducing apparatus 30 is preferably a timing servo system magnetic recording and reproducing apparatus. The magnetic recording medium of the present technology is suitable for use in a timing servo system magnetic recording and reproducing apparatus.

The recording and reproducing apparatus 30 is connected to information processing apparatuses such as a server 41 and a personal computer (hereinafter referred to as “PC”) 42 via a network 43, and is configured to be able to record data supplied from these information processing apparatuses in the magnetic recording cartridge 10A. The shortest recording wavelength of the recording and reproducing apparatus 30 is preferably 100 nm or less, more preferably 75 nm or less, still more preferably 60 nm or less, and particularly preferably 50 nm or less.

As illustrated in FIG. 3, the recording and reproducing apparatus includes a spindle 31, a reel 32 on the recording and reproducing apparatus side, a spindle driving apparatus 33, a reel driving apparatus 34, a plurality of guide rollers 35, a head unit 36, a communication interface (hereinafter, I/F) 37, and a control apparatus 38.

The spindle 31 is configured to be able to mount the magnetic recording cartridge 10A. The magnetic recording cartridge 10A conforms to the linear tape open (LTO) standard, and accommodates a rotatable single reel 10C in which the magnetic recording medium 10 is wound around a cartridge case 10B. In the magnetic recording medium 10, V-shaped servo patterns are recorded in advance as a servo signal. The reel 32 is configured to be able to fix the leading end of the magnetic recording medium 10 drawn out from the magnetic recording cartridge 10A.

The present technology also provides a magnetic recording cartridge including the magnetic recording medium according to the present technology. In the magnetic recording cartridge, the magnetic recording medium may be wound around a reel, for example.

The spindle driving apparatus 33 is an apparatus that rotationally drives the spindle 31. The reel driving apparatus 34 is an apparatus that rotationally drives the reel 32. When data is recorded on or reproduced from the magnetic recording medium 10, the spindle driving apparatus 33 and the reel driving apparatus 34 rotationally drive the spindle 31 and the reel 32 to cause the magnetic recording medium 10 to travel. The guide roller 35 is a roller for guiding the travel of the magnetic recording medium 10.

The head unit 36 includes: a plurality of recording heads for recording a data signal on the magnetic recording medium 10; a plurality of reproducing heads for reproducing the data signal recorded on the magnetic recording medium 10; and a plurality of servo heads for reproducing a servo signal recorded on the magnetic recording medium 10. As the recording head, for example, a ring-type head can be used, but the type of the recording head is not limited thereto.

The communication I/F 37 is for communicating with information processing apparatuses such as the server 41 and the PC 42, and is connected to the network 43.

The control apparatus 38 controls the entire recording and reproducing apparatus 30. For example, in response to a request from the information processing apparatus such as the server 41 and the PC 42, the control apparatus 38 records a data signal supplied from the information processing apparatus on the magnetic recording medium 10 by the head unit 36. Furthermore, in response to a request from the information processing apparatus such as the server 41 and the PC 42, the control apparatus 38 reproduces the data signal recorded on the magnetic recording medium 10 by the head unit 36 and supplies the data signal to the information processing apparatus.

Furthermore, the control apparatus 38 detects a change in width of the magnetic recording medium 10 on the basis of a servo signal supplied from the head unit 36. Specifically, a plurality of V-shaped servo patterns is recorded as servo signals on the magnetic recording medium 10, and the head unit 36 can simultaneously reproduce two different servo patterns by two servo heads on the head unit 36 to provide respective servo signals. The position of the head unit 36 is controlled so as to follow the servo pattern using relative position information between the servo pattern and the head unit, the relative position information being obtained from the servo signal. At the same time, the distance information between the servo patterns can also be obtained by comparing the two servo signal waveforms. By comparing the distance information between the servo patterns obtained at the time of each measurement, it is possible to obtain a change in distance between the servo patterns at the time of each measurement. In addition, a change in width of the magnetic recording medium 10 can also be calculated by adding distance information between servo patterns at the time of servo pattern recording. The control apparatus 38 controls the rotational driving of the spindle driving apparatus 33 and the reel driving apparatus 34 on the basis of the change in distance between the servo patterns obtained as described above or the calculated change in width of the magnetic recording medium 10, and adjusts the tension in the longitudinal direction of the magnetic recording medium 10 such that the width of the magnetic recording medium 10 becomes a prescribed width or a substantially prescribed width. As a result, a change in width of the magnetic recording medium 10 can be suppressed.

[Action of Recording and Reproducing Apparatus]

Next, an action of the recording and reproducing apparatus 30 having the configuration described above will be described.

First, the magnetic recording cartridge 10A is mounted on the recording and reproducing apparatus 30, the leading end of the magnetic recording medium 10 is drawn out and transferred to the reel 32 via the plurality of guide rollers 35 and the head unit 36, and the leading end of the magnetic recording medium 10 is attached to the reel 32.

Next, when an operation part (not illustrated) is operated, the spindle driving apparatus 33 and the reel driving apparatus 34 are driven by the control of the control apparatus 38, and the spindle 31 and the reel 32 are rotated in the same direction so that the magnetic recording medium 10 travels from the reel 10C toward the reel 32. As a result, the head unit 36 records information on the magnetic recording medium 10 or reproduces information recorded on the magnetic recording medium 10 while the magnetic recording medium 10 is wound around the reel 32.

Furthermore, in a case where the magnetic recording medium 10 is rewound around the reel 10C, the spindle 31 and the reel 32 are rotationally driven in a direction reverse to the direction described above, whereby the magnetic recording medium 10 travels from the reel 32 to the reel 10C. Also at the time of the rewinding, the head unit 36 records information on the magnetic recording medium 10 or reproduces information recorded on the magnetic recording medium 10.

### (6) Modification Examples

### Modification Example 1

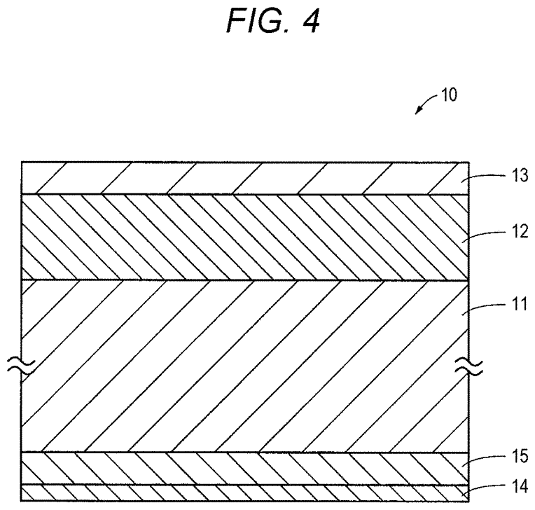

As illustrated in FIG. 4, the magnetic recording medium 10 may further include a barrier layer 15 provided on at least one surface of the base layer 11. The barrier layer 15 is a layer for suppressing dimensional deformation of the base layer 11 according to the environment. For example, the hygroscopicity of the base layer 11 can be given as an example of a cause of the dimensional deformation, and the barrier layer 15 can reduce the rate at which moisture penetrates into the base layer 11. The barrier layer 15 contains a metal or a metal oxide. As the metal, for example, at least one of Al, Cu, Co, Mg, Si, Ti, V, Cr, Mn, Fe, Ni, Zn, Ga, Ge, Y, Zr, Mo, Ru, Pd, Ag, Ba, Pt, Au, or Ta can be used. As the metal oxide, for example, at least one of Al₂O₃, CuO, CoO, SiO₂, Cr₂O₃, TiO₂, Ta₂O₅, or ZrO₂ can be used, and any of the oxides of the metals described above can also be used. Furthermore, diamond-like carbon (DLC), or diamond, and the like can also be used.

The average thickness of the barrier layer 15 is preferably 20 nm or more and 1,000 nm or less, and more preferably 50 nm or more and 1,000 nm or less. The average thickness of the barrier layer 15 is obtained in a manner similar to the average thickness tₘ of the magnetic layer 13. However, the magnification of the TEM image is appropriately adjusted according to the thickness of the barrier layer 15.

### Modification Example 2

The magnetic recording medium 10 may be incorporated into a library apparatus. That is, the present technology also provides a library apparatus including at least one magnetic recording medium 10. The library apparatus has a configuration capable of adjusting tension applied in the longitudinal direction of the magnetic recording medium 10, and may include a plurality of the recording and reproducing apparatuses 30 described above.

### Modification Example 3

The magnetic recording medium 10 may be subjected to servo signal write processing by a servo writer. The servo writer can keep the width of the magnetic recording medium 10 constant or substantially constant by adjusting the tension in the longitudinal direction of the magnetic recording medium 10 at the time of recording a servo signal or the like. In this case, the servo writer can include a detection apparatus that detects the width of the magnetic recording medium 10. The servo writer can adjust the tension in the longitudinal direction of the magnetic recording medium 10 on the basis of the detection result of the detection apparatus.

### 3. Second Embodiment (Example of Vacuum Thin Film Type Magnetic Recording Medium)

### (1) Configuration of Magnetic Recording Medium

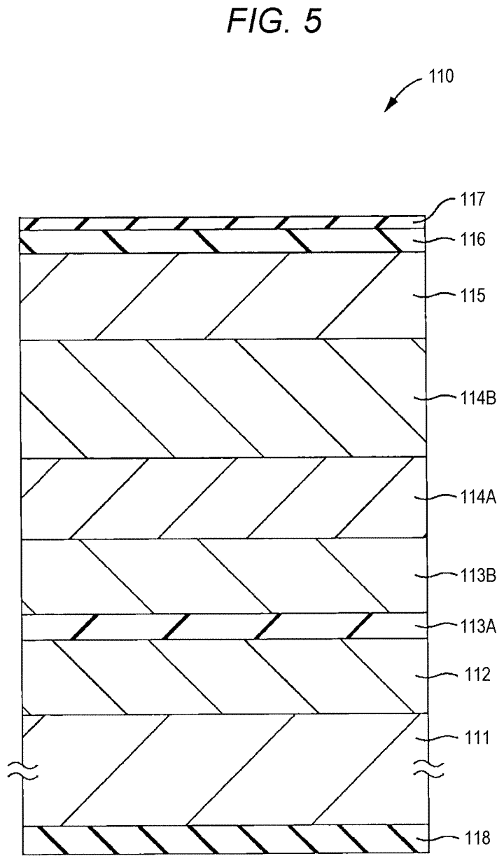

A magnetic recording medium 110 according to the second embodiment is a long perpendicular magnetic recording medium, and includes a film-shaped base layer 111, a soft magnetic underlayer (hereinafter referred to as “SUL”) 112, a first seed layer 113A, a second seed layer 113B, a first underlayer 114A, a second underlayer 114B, and a magnetic layer 115 as illustrated in FIG. 5. The SUL 112, the first and second seed layers 113A and 113B, the first and second underlayers 114A and 114B, and the magnetic layer 115 can be, for example, a vacuum thin film such as a layer formed by sputtering (hereinafter, also referred to as a “sputtering layer”).

The SUL 112, the first and second seed layers 113A and 113B, and the first and second underlayers 114A and 114B are provided between one main surface (hereinafter, referred to as a “surface”) of the base layer 111 and the magnetic layer 115, and the SUL 112, the first seed layer 113A, the second seed layer 113B, the first underlayer 114A, and the second underlayer 114B are laminated in this order from the base layer 111 toward the magnetic layer 115. By providing a vacuum thin film such as a layer formed on the surface of the base layer 111 by sputtering (hereinafter, also referred to as a “sputtering layer”), the water vapor transmission rate can be further reduced more than that of the single base layer itself.

The magnetic recording medium 110 may further include: a protective layer 116 provided on the magnetic layer 115; and a lubricating layer 117 provided on the protective layer 116, as necessary. Furthermore, the magnetic recording medium 110 may further include a back layer 118 provided on the other main surface (hereinafter, referred to as a “back surface”) of the base layer 111 as necessary.

Hereinafter, the longitudinal direction of the magnetic recording medium 110 (the longitudinal direction of the base layer 111) is referred to as a machine direction (MD). Here, the machine direction means a relative movement direction of the recording and reproducing head with respect to the magnetic recording medium 110, that is, a direction in which the magnetic recording medium 110 travels at the time of recording and reproduction.

The magnetic recording medium 110 according to the second embodiment is preferred for use as a data archive storage medium whose demand is expected to increase more and more in the future. The magnetic recording medium 110 can achieve, for example, a surface recording density of 10 times or more the current application type magnetic recording medium for storage, that is, a surface recording density of 50 Gb/in² or more. In a case where a general linear recording system data cartridge is configured using the magnetic recording medium 110 having such a surface recording density, it is possible to perform large-capacity recording of 100 TB or more per data cartridge.

The magnetic recording medium 110 according to the second embodiment is preferred for use in a recording and reproducing apparatus (recording and reproducing apparatus for recording and reproducing data) including a ring-type recording head, and a giant magnetoresistive (GMR) type or tunneling magnetoresistive (TMR) type reproducing head. Furthermore, in the magnetic recording medium 110 according to the second embodiment preferably, a ring-type recording head is used as a servo signal writing head. A data signal is perpendicularly recorded on the magnetic layer 115 by a ring-type recording head, for example. Furthermore, a servo signal is perpendicularly recorded on the magnetic layer 115 by a ring-type recording head, for example.

### (2) Description of Each Layer

(Base Layer)

Since the description regarding the base layer 11 in the first embodiment applies to the base layer 111, the description of the base layer 111 is omitted.

(SUL)

The SUL 112 contains a soft magnetic material in an amorphous state. The soft magnetic material contains, for example, at least one of a Co-based material or a Fe-based material. The Co-based material includes, for example, CoZrNb, CoZrTa, or CoZrTaNb. The Fe-based material includes, for example, FeCoB, FeCoZr, or FeCoTa.

The SUL 112 is a single-layer SUL and is provided directly on the base layer 111. The average thickness of the SUL 112 is preferably 10 nm or more and 50 nm or less, and more preferably 20 nm or more and 30 nm or less.

The average thickness of the SUL 112 is obtained by the same method as the method for measuring the average thickness of the magnetic layer 13 in the first embodiment. Note that the average thicknesses (that is, the average thicknesses of the first and second seed layers 113A and 113B, the first and second underlayers 114A and 114B, and the magnetic layer 115) of the layers other than the SUL 112 to be described later are also obtained by the same method as the method for measuring the average thickness of the magnetic layer 13 in the first embodiment. However, the magnification of the TEM image is appropriately adjusted according to the thickness of each layer.

(First and Second Seed Layers)

The first seed layer 113A contains an alloy containing Ti and Cr, and has an amorphous state. Furthermore, this alloy may further contain O (oxygen). This oxygen may be impurity oxygen contained in a trace amount in the first seed layer 113A when the first seed layer 113A is formed by a film forming method such as a sputtering method.

Here, the “alloy” means at least one of a solid solution, an eutectic material, an intermetallic compound, or the like containing Ti and Cr. The “amorphous state” means that halo is observed in X-ray diffraction, electron beam diffraction, or the like, and a crystal structure cannot be specified.

The atomic ratio of Ti to the total amount of Ti and Cr contained in the first seed layer 113A is preferably in a range of 30 atomic % or more and 100 atomic % or less, and more preferably in a range of 50 atomic % or more and 100 atomic % or less. When the atomic ratio of Ti is less than 30%, the (100) plane of the body-centered cubic lattice (bcc) structure of Cr is oriented, and there is a possibility that the orientation of the first and second underlayers 114A and 114B formed above the first seed layer 113A is deteriorated.

The above-described atomic ratio of Ti is obtained as follows. Depth direction analysis (depth profile measurement) of the first seed layer 113A is performed by auger electron spectroscopy (hereinafter referred to as “AES”) while the magnetic recording medium 110 is subjected to ion-milling from the magnetic layer 115 side. Next, the average composition (average atomic ratio) of Ti and Cr in the film thickness direction is obtained from the obtained depth profile. Next, the above-described atomic ratio of Ti is obtained using the obtained average composition of Ti and Cr.

In a case where the first seed layer 113A contains Ti, Cr, and O, the atomic ratio of O to the total amount of Ti, Cr, and O contained in the first seed layer 113A is preferably 15 atomic % or less, and more preferably 10 atomic % or less. When the atomic ratio of O exceeds 15 atomic %, TiO₂ crystals are generated, thereby affecting the formation of crystal nucleus of the first and second underlayers 114A and 114B formed above the first seed layer 113A, and there is a possibility that the orientation of the first and second underlayers 114A and 114B is deteriorated. The above-described atomic ratio of O is obtained using an analysis method similar to the above-described atomic ratio of Ti.

The alloy contained in the first seed layer 113A may further contain elements other than Ti and Cr as additive elements. The additive element may be, for example, one or more elements selected from the group consisting of Nb, Ni, Mo, Al, and W.

The average thickness of the first seed layer 113A is preferably 2 nm or more and 15 nm or less, and more preferably 3 nm or more and 10 nm or less.

The second seed layer 113B contains, for example, NiW or Ta, and has a crystalline state. The average thickness of the second seed layer 113B is preferably 3 nm or more and 20 nm or less, and more preferably 5 nm or more and 15 nm or less.

The first and second seed layers 113A and 113B have a crystal structure similar to those of the first and second underlayers 114A and 114B, and are not seed layers provided for the purpose of crystal growth, but are seed layers that improve the perpendicular orientation of the first and second underlayers 114A and 114B by the amorphous state of the first and second seed layers 113A and 113B.

(First and Second Underlayers)

The first and second underlayers 114A and 114B preferably have a crystal structure similar to the magnetic layer 115. In a case where the magnetic layer 115 contains a Co-based alloy, it is preferable that the first and second underlayers 114A and 114B contain a material having a hexagonal close-packed (hcp) structure similar to that of the Co-based alloy, and the c-axis of the structure be oriented in a direction perpendicular to the film surface (that is, the film thickness direction). This is because the orientation of the magnetic layer 115 can be enhanced, and the lattice constant matching between the second underlayer 114B and the magnetic layer 115 can be made relatively good. As the material having a hexagonal close-packed (hcp) structure, a material containing Ru is preferably used, and specifically, Ru single substance or a Ru alloy is preferable. Examples of the Ru alloy include Ru alloy oxides such as Ru—SiO₂, Ru—TiO₂, and Ru—ZrO₂, and the Ru alloy may be any one of these.

As described above, similar materials can be used as the materials of the first and second underlayers 114A and 114B. However, the intended effects of the first and second underlayers 114A and 114B are different. Specifically, the second underlayer 114B has a film structure that promotes the granular structure of the magnetic layer 115 as an upper layer thereof, and the first underlayer 114A has a film structure with high crystal orientation. In order to obtain such film structures, it is preferable that film formation conditions such as sputtering conditions of the first and second underlayers 114A and 114B be different from each other.

The average thickness of the first underlayer 114A is preferably 3 nm or more and 15 nm or less, and more preferably 5 nm or more and 10 nm or less. The average thickness of the second underlayer 114B is preferably 7 nm or more and 40 nm or less, and more preferably 10 nm or more and 25 nm or less.

(Magnetic Layer)

The magnetic layer (also referred to as a recording layer) 115 can be a perpendicular magnetic recording layer in which magnetic materials are perpendicularly oriented. From the viewpoint of improving the recording density, the magnetic layer 115 is preferably a granular magnetic layer containing a Co-based alloy. The granular magnetic layer includes: ferromagnetic crystal grains containing a Co-based alloy; and a nonmagnetic grain boundary (nonmagnetic material) surrounding the ferromagnetic crystal grains. More specifically, the granular magnetic layer includes: columns (columnar crystals) containing a Co-based alloy; and a nonmagnetic grain boundary (for example, an oxide such as SiO₂) that surrounds the columns and magnetically separates the columns. With this structure, the magnetic layer 115 having a structure in which the respective columns are magnetically separated can be configured.

The Co-based alloy has a hexagonal close-packed (hcp) structure, and the c-axis of the structure is oriented in a direction perpendicular to the film surface (film thickness direction). As the Co-based alloy, a CoCrPt-based alloy containing at least Co, Cr, and Pt is preferably used. The CoCrPt-based alloy may further contain an additive element. Examples of the additive element include one or more elements selected from the group consisting of Ni, Ta, and the like.

The nonmagnetic grain boundary surrounding the ferromagnetic crystal grains contains a nonmagnetic metal material. Here, the metal includes a semimetal. As the nonmagnetic metal material, for example, at least one of a metal oxide or a metal nitride can be used, and from the viewpoint of more stably maintaining the granular structure, it is preferable to use a metal oxide. Examples of the metal oxide include metal oxides containing at least one or more element selected from the group consisting of Si, Cr, Co, Al, Ti, Ta, Zr, Ce, Y, Hf, and the like, and metal oxides containing at least Si oxides (that is, SiO₂) are preferable. Specific examples of the metal oxide include SiO₂, Cr₂O₃, CoO, Al₂O₃, TiO₂, Ta₂O₅, ZrO₂, HfO₂, and the like. Examples of the metal nitride include metal nitrides containing at least one or more elements selected from the group consisting of Si, Cr, Co, Al, Ti, Ta, Zr, Ce, Y, Hf, and the like. Specific examples of the metal nitride include SiN, TiN, AlN, and the like.

It is preferable that the CoCrPt-based alloy contained in the ferromagnetic crystal grains and the Si oxide contained in the nonmagnetic grain boundary have an average composition represented by the following formula (1). This is because it is possible to achieve the saturation magnetization amount Ms that enables suppression of the influence of the demagnetizing field and securing of a sufficient reproduction output, thereby further improving the recording and reproducing characteristics.

(CoₓPt_{y}Cr_{100-x-y})_{100-z}—(SiO₂)_{z} (1)

where x, y, and z are values within the ranges of 69≤x≤75, 10≤y≤16, and 9≤z≤12, respectively.

Note that the composition described above can be obtained as follows. Depth direction analysis of the magnetic layer 115 is performed by AES while the magnetic recording medium 110 is subjected to ion-milling from the magnetic layer 115 side, and the average composition (average atomic ratio) of Co, Pt, Cr, Si, and O in the film thickness direction is obtained.

The average thickness tₘ [nm] of the magnetic layer 115 is preferably 9 nm≤tₘ≤90 nm, more preferably 9 nm≤tₘ≤20 nm, and still more preferably 9 nm≤tₘ≤15 nm. The magnetic layer 115 having an average thickness tₘ within the numerical range described above allows electromagnetic conversion characteristics to be improved.

(Protective Layer)

The protective layer 116 contains, for example, a carbon material or silicon dioxide (SiO₂), and preferably contains a carbon material from the viewpoint of the film strength of the protective layer 116. Examples of the carbon material include graphite, diamond-like carbon (DLC), or diamond, and the like.

(Lubricating Layer)

The lubricating layer 117 contains at least one lubricant. The lubricating layer 117 may further contain various additives, for example, a rust inhibitor or the like, as necessary. The lubricant has at least two carboxyl groups and one ester bond, and contains at least one of carboxylic acid-based compounds represented by the following general formula (1). The lubricant may further contain a lubricant other than the carboxylic acid-based compound represented by the following general formula (1).

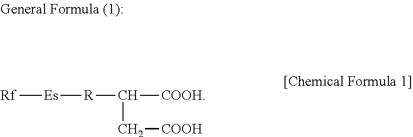

(In the formula, Rf is an unsubstituted or substituted saturated or unsaturated fluorine-containing hydrocarbon group or a hydrocarbon group, Es is an ester bond, and R may be absent, but is an unsubstituted or substituted saturated or unsaturated hydrocarbon group.)

The carboxylic acid-based compound described above is preferably represented by the following general formula (2) or (3).

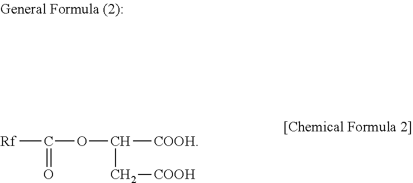

(In the formula, Rf is an unsubstituted or substituted saturated or unsaturated fluorine-containing hydrocarbon group or a hydrocarbon group)

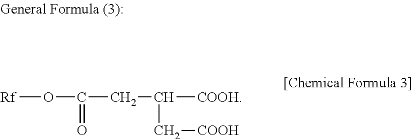

(In the formula, Rf is an unsubstituted or substituted saturated or unsaturated fluorine-containing hydrocarbon group or a hydrocarbon group.)

The lubricant preferably contains one or both of the carboxylic acid-based compounds represented by the general formulae (2) and (3) described above.

When a lubricant containing the carboxylic acid-based compound represented by the general formula (1) is applied to the magnetic layer 115, the protective layer 116, or the like, a lubricating action is exerted by the cohesive force between the fluorine-containing hydrocarbon groups or hydrocarbon groups Rf which are hydrophobic groups. In a case where the Rf group is a fluorine-containing hydrocarbon group, the total number of carbon atoms is 6 to 50, and the total number of carbon atoms of the fluorinated hydrocarbon group is preferably 4 to 20. The Rf group may be, for example, a saturated or unsaturated linear, branched, or cyclic hydrocarbon group, but preferably can be a saturated linear hydrocarbon group.

For example, in a case where the Rf group is a hydrocarbon group, the Rf group is desirably a group represented by the following general formula (4):

General Formula (4):

CH₃ [symbol] CH₂ [symbol] ₗ [Chemical Formula 4]

where l is an integer selected from the range of 8 to 30, more desirably 12 to 20.

Furthermore, in a case where the Rf group is a fluorine-containing hydrocarbon group, the Rf group is desirably a group represented by the following general formula (5):

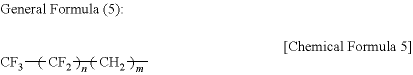

where m and n are integers independently selected from the following ranges respectively: m is 2 to 20, n is 3 to 18, and more desirably m is 4 to 13, n is 3 to 10.

The fluorinated hydrocarbon group may be located at one position in a concentrated manner in the molecule as described above, or may be located in a dispersed manner in the molecule as in the following general formula (6), and may be not only —CF₃ or —CF₂—, but also —CHF₂, —CHF—, or the like:

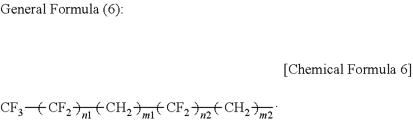

where, in the general formulae (5) and (6), n1+n2 is n, and m1+m2 is m.

The reason why the number of carbon atoms is limited in the general formulae (4), (5), and (6) as described above is that when the number of carbon atoms (l or sum of m and n) constituting the alkyl group or the fluorine-containing alkyl group is equal to or more than the lower limit described above, the length thereof becomes an appropriate length, the cohesive force between hydrophobic groups is effectively exhibited, a good lubricating action is expressed, and the friction/wear durability is improved. Furthermore, when the number of carbon atoms is equal to or less than the upper limit described above, the solubility of the lubricant containing the carboxylic acid-based compound in a solvent is kept good.

In particular, when the Rf group in the general formulae (1), (2), and (3) contains a fluorine atom, effects of reducing the friction coefficient and further, improving traveling performance, and the like are provided. However, it is preferable to secure the stability of the ester bond and prevent hydrolysis by providing a hydrocarbon group between the fluorine-containing hydrocarbon group and the ester bond, to separate the fluorine-containing hydrocarbon group and the ester bond.

Furthermore, the Rf group may have a fluoroalkyl ether group or a perfluoropolyether group.

The R group in the general formula (1) may be absent, but in a case where the R group is present, a hydrocarbon chain having a relatively small number of carbon atoms is preferable.

Furthermore, the Rf group or the R group may include one or more elements selected from nitrogen, oxygen, sulfur, phosphorus, and halogen as constituent elements, and may further have a hydroxyl group, a carboxyl group, a carbonyl group, an amino group, an ester bond, and the like in addition to the functional groups described above.

Specifically, the carboxylic acid-based compound represented by the general formula (1) is preferably at least one of the following compounds. That is, the lubricant preferably contains at least one of the following compounds.
CF₃(CF₂)₇(CH₂)₁₀COOCH(COOH)CH₂COOH
CF₃(CF₂)₃(CH₂)₁₀COOCH(COOH)CH₂COOH
C₁₇H₃₅COOCH(COOH)CH₂COOH
CF₃(CF₂)₇(CH₂)₂OCOCH₂CH(C₁₈H₃₇)COOCH(COOH)CH₂COOH
CF₃(CF₂)₇COOCH(COOH)CH₂COOH
CHF₂(CF₂)₇COOCH(COOH)CH₂COOH
CF₃(CF₂)₇(CH₂)₂OCOCH₂CH(COOH)CH₂COOH
CF₃(CF₂)₇(CH₂)₆OCOCH₂CH(COOH)CH₂COOH
CF₃(CF₂)₇(CH₂)₁₁OCOCH₂CH(COOH)CH₂COOH
CF₃(CF₂)₃(CH₂)₆OCOCH₂CH(COOH)CH₂COOH
C₁₃H₃₇OCOCH₂CH(COOH)CH₂COOH
CF₃(CF₂)₇(CH₂)₄COOCH(COOH)CH₂COOH
CF₃(CF₂)₃(CH₂)₄COOCH(COOH)CH₂COOH
CF₃(CF₂)₃(CH₂)₇COOCH(COOH)CH₂COOH
CF₃(CF₂)₉(CH₂)₁₀COOCH(COOH)CH₂COOH
CF₃(CF₂)₇(CH₂)₁₂COOCH(COOH)CH₂COOH
CF₃(CF₂)₅(CH₂)₁₀COOCH(COOH)CH₂COOH
CF₃(CF₂)₇CH(C₉H₁₉) CH₂CH═CH(CH₂)₇COOCH(COOH)CH₂COOH
CF₃(CF₂)₇CH(C₆H₁₃)(CH₂)₇COOCH(COOH)CH₂COOH
CH₃(CH₂)₃(CH₂CH₂CH(CH₂CH₂(CF₂)₉CF₃))₂(CH₂)₇COOCH(COOH)CH₂COOH

The carboxylic acid-based compound represented by the general formula (1) is soluble in a non-fluorine-based solvent having a small load on the environment, and has an advantage that operations such as application, immersion, and spraying can be performed using, for example, a general-purpose solvent such as a hydrocarbon-based solvent, a ketone-based solvent, an alcohol-based solvent, and an ester-based solvent. Specifically, examples of the general-purpose solvent can include solvents such as hexane, heptane, octane, decane, dodecane, benzene, toluene, xylene, cyclohexane, methyl ethyl ketone, methyl isobutyl ketone, methanol, ethanol, isopropanol, diethyl ether, tetrahydrofuran, dioxane, and cyclohexanone.

In a case where the protective layer 116 contains a carbon material, when the carboxylic acid-based compound described above is applied as a lubricant onto the protective layer 116, two carboxyl groups and at least one ester bond group, which are polar group moieties of the molecules of the lubricant, are adsorbed onto the protective layer 116, and the lubricating layer 117 having particularly good durability can be formed due to the cohesive force between hydrophobic groups.

Note that the lubricant is not only held as the lubricating layer 117 on the surface of the magnetic recording medium 110 as described above, but may also be contained and held in layers such as the magnetic layer 115 and the protective layer 116 constituting the magnetic recording medium 110.

(Back Layer)

The description regarding the back layer 14 in the first embodiment applies to the back layer 118.

### (3) Physical Properties and Structure

All of the descriptions regarding the physical properties and the structure described in the item (3) of 2. described above are also applied to the second embodiment. For example, the water vapor transmission rate measured according to the Lyssy method, the Young's modulus, and the humidity expansion coefficient β of the magnetic recording medium 110 may be similar to those in the first embodiment. Therefore, the description of physical properties and the structure of the magnetic recording medium of the second embodiment will be omitted.

### (4) Configuration of Sputtering Apparatus

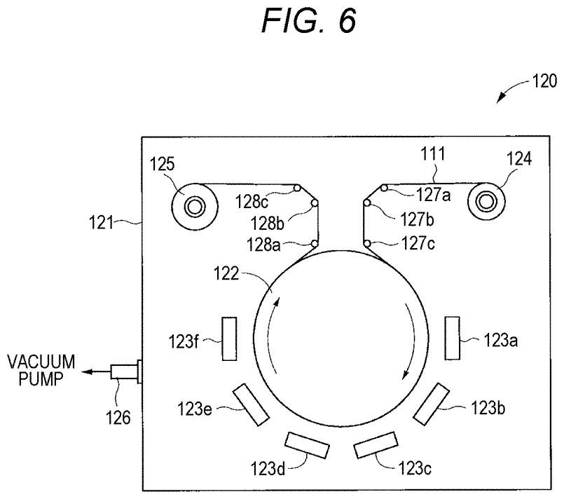

Hereinafter, an example of the configuration of a sputtering apparatus 120 used for producing the magnetic recording medium 110 according to the second embodiment will be described with reference to FIG. 6. The sputtering apparatus 120 is a continuous winding type sputtering apparatus used for formation of the SUL 112, the first seed layer 113A, the second seed layer 113B, the first underlayer 114A, the second underlayer 114B, and the magnetic layer 115, and includes a film forming chamber 121, a drum 122 which is a metal can (rotating body), cathodes 123a to 123f, a supply reel 124, a winding reel 125, and a plurality of guide rollers 127a to 127c and 128a to 128c as illustrated in FIG. 6. The sputtering apparatus 120 is, for example, an apparatus of a DC (direct current) magnetron sputtering method, but the sputtering method is not limited to this method.

The film forming chamber 121 is connected to a vacuum pump (not illustrated) via an exhaust port 126, and the atmosphere in the film forming chamber 121 is set to a predetermined degree of vacuum by the vacuum pump. Inside the film forming chamber 121, the drum 122 having a rotatable configuration, the supply reel 124, and the winding reel 125 are disposed. Inside the film forming chamber 121, a plurality of the guide rollers 127a to 127c for guiding the conveyance of the base layer 111 between the supply reel 124 and the drum 122 is provided, and a plurality of the guide rollers 128a to 128c for guiding the conveyance of the base layer 111 between the drum 122 and the winding reel 125 is provided. At the time of sputtering, the base layer 111 unwound from the supply reel 124 is wound around the winding reel 125 via the guide rollers 127a to 127c, the drum 122, and the guide rollers 128a to 128c. The drum 122 has a cylindrical shape, and the long base layer 111 is conveyed along a cylindrical peripheral surface of the drum 122. The drum 122 is provided with a cooling mechanism (not illustrated), and is cooled to, for example, about −20° C. at the time of sputtering. Inside the film forming chamber 121, a plurality of the cathodes 123a to 123f is disposed to face the peripheral surface of the drum 122. Targets are set on these cathodes 123a to 123f, respectively. Specifically, targets for forming the SUL 112, the first seed layer 113A, the second seed layer 113B, the first underlayer 114A, the second underlayer 114B, and the magnetic layer 115, are set on the cathodes 123a, 123b, 123c, 123d, 123e, and 123f, respectively. A plurality of types of films, that is, the SUL 112, the first seed layer 113A, the second seed layer 113B, the first underlayer 114A, the second underlayer 114B, and the magnetic layer 115 are simultaneously formed by the cathodes 123a to 123f.

In the sputtering apparatus 120 having the configuration described above, the SUL 112, the first seed layer 113A, the second seed layer 113B, the first underlayer 114A, the second underlayer 114B, and the magnetic layer 115 can be continuously formed by a roll-to-roll method.

### (5) Method for Producing Magnetic Recording Medium

The magnetic recording medium 110 according to the second embodiment can be produced, for example, as follows.

First, the SUL 112, the first seed layer 113A, the second seed layer 113B, the first underlayer 114A, the second underlayer 114B, and the magnetic layer 115 are sequentially formed on the surface of the base layer 111 using the sputtering apparatus 120 illustrated in FIG. 6. Specifically, the film formation is performed as follows. First, the film forming chamber 121 is evacuated until a predetermined pressure is reached. Thereafter, targets set on the cathodes 123a to 123f are sputtered while a process gas such as an Ar gas is introduced into the film forming chamber 121. As a result, the SUL 112, the first seed layer 113A, the second seed layer 113B, the first underlayer 114A, the second underlayer 114B, and the magnetic layer 115 are sequentially formed on the surface of the traveling base layer 111.

The atmosphere of the film forming chamber 121 at the time of sputtering is set to, for example, about 1×10⁻⁵ Pa to 5×10⁻⁵ Pa. The film thicknesses and characteristics of the SUL 112, the first seed layer 113A, the second seed layer 113B, the first underlayer 114A, the second underlayer 114B, and the magnetic layer 115 can be controlled by adjusting the tape line speed at which the base layer 111 is wound up, the pressure (sputtering gas pressure) of a process gas such as an Ar gas introduced at the time of sputtering, the input power, and the like.

Next, the protective layer 116 is formed on the magnetic layer 115. As a method for forming the protective layer 116, for example, a chemical vapor deposition (CVD) method or a physical vapor deposition (PVD) method can be used.

Next, a coating material for forming a back layer is prepared by kneading and dispersing a binder, inorganic particles, a lubricant, and the like in a solvent. Next, the back layer 118 is formed on the back surface of the base layer 111 by applying the coating material for forming a back layer on the back surface of the base layer 111 and drying the coating material.

Next, for example, a lubricant is applied onto the protective layer 116 to form the lubricating layer 117. As a method for applying the lubricant, for example, various application methods such as gravure coating and dip coating can be used. Next, the magnetic recording medium 110 is cut into a predetermined width as necessary. As a result, the magnetic recording medium 110 illustrated in FIG. 5 is obtained.

### (6) Modification Examples

The magnetic recording medium 110 may further include an underlayer between the base layer 111 and the SUL 112. The SUL 112 has an amorphous state, and therefore does not play a role of promoting epitaxial growth of layers formed on the SUL 112, but is required not to disturb the crystal orientation of the first and second underlayers 114A and 114B formed on the SUL 112. For this purpose, it is preferable that the soft magnetic material have a fine structure that does not form columns, but in a case where the influence of the release of gas such as moisture from the base layer 111 is significant, the soft magnetic material becomes coarse, and there is a possibility that the crystal orientation of the first and second underlayers 114A and 114B formed on the SUL 112 is disturbed. In order to suppress the influence of the release of gas such as moisture from the base layer 111, it is preferable to provide an underlayer that contains an alloy containing Ti and Cr and has an amorphous state between the base layer 111 and the SUL 112 as described above. As a specific configuration of this underlayer, a configuration similar to that of the first seed layer 113A of the second embodiment can be adopted.

The magnetic recording medium 110 does not necessarily include at least one layer of the second seed layer 113B and the second underlayer 114B. However, from the viewpoint of improving the SNR, it is more preferable to include both the second seed layer 113B and the second underlayer 114B.

The magnetic recording medium 110 may include an antiparallel coupled SUL (APC-SUL) in place of the single-layer SUL.

### 4. Third Embodiment (Example of Vacuum Thin Film Type Magnetic Recording Medium)

### (1) (Configuration of Magnetic Recording Medium)

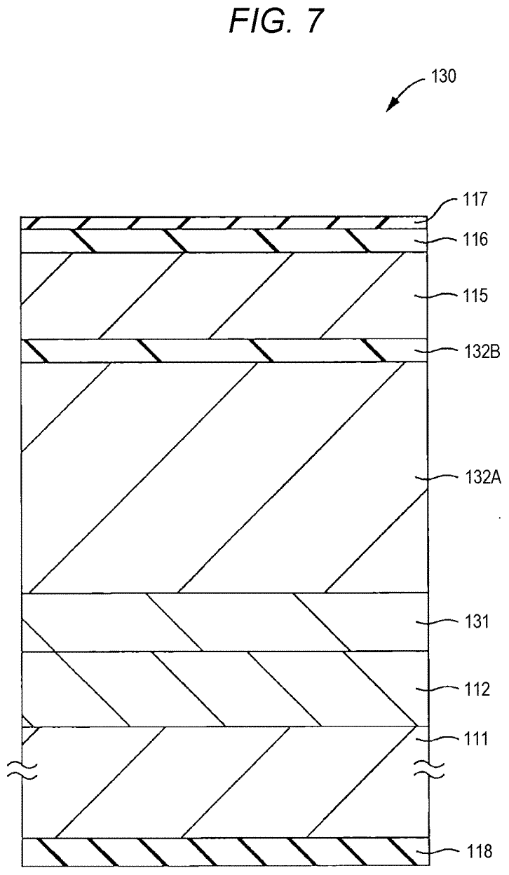

As illustrated in FIG. 7, a magnetic recording medium 130 according to the third embodiment includes the base layer 111, the SUL 112, a seed layer 131, a first underlayer 132A, a second underlayer 132B, and the magnetic layer 115. Note that, in the third embodiment, the parts similar to those in the second embodiment are denoted by the same reference numerals, and the description thereof will be omitted.

The SUL 112, the seed layer 131, the first and second underlayers 132A and 132B are provided between one main surface of the base layer 111 and the magnetic layer 115, and the SUL 112, the seed layer 131, the first underlayer 132A, and the second underlayer 132B are laminated in this order from the base layer 111 toward the magnetic layer 115.

### (2) (Description of Each Layer)

(Seed Layer)

The seed layer 131 contains Cr, Ni, and Fe, has a face-centered cubic lattice (fcc) structure, and the (111) plane of the face-centered cubic structure is preferentially oriented to be parallel to the surface of the base layer 111. Here, the preferential orientation means a state in which, in the θ-2θ scan of the X-ray diffraction method, the intensity of the diffraction peak attributed to the (111) plane of the face-centered cubic lattice structure is larger than the intensities of the diffraction peaks attributed to other crystal planes, or a state in which only the intensity of the diffraction peak attributed to the (111) plane of the face-centered cubic lattice structure is observed in the θ-2θ scan of the X-ray diffraction method.

The intensity ratio of the X-ray diffraction of the seed layer 131 is preferably 60 cps/nm or more, more preferably 70 cps/nm or more, and still more preferably 80 cps/nm or more from the viewpoint of improving the SNR. Here, the intensity ratio of the X-ray diffraction of the seed layer 131 is a value (I/D (cps/nm)) obtained by dividing the intensity I (cps) of the X-ray diffraction of the seed layer 131 by the average thickness D (nm) of the seed layer 131.

Cr, Ni, and Fe contained in the seed layer 131 preferably have an average composition represented by the following formula (2):

Cr_{X}(Ni_{Y}Fe_{100-Y})_{100-X} (2)

where X and Y are in the ranges of 10≤X≤45 and 60≤Y≤90, respectively.

When X is in the range described above, the (111) orientation of the face-centered cubic lattice structure of Cr, Ni, and Fe is improved, and a better SNR can be obtained. Similarly, when Y is within the range described above, the (111) orientation of the face-centered cubic lattice structure of Cr, Ni, and Fe is improved, and a better SNR can be obtained.

The average thickness of the seed layer 131 is preferably 5 nm or more and 40 nm or less. When the average thickness of the seed layer 131 is set within this range, the (111) orientation of the face-centered cubic lattice structure of Cr, Ni, and Fe is improved, and a better SNR can be obtained. Note that the average thickness of the seed layer 131 is obtained in a manner similar to the magnetic layer 13 in the first embodiment. However, the magnification of the TEM image is appropriately adjusted according to the thickness of the seed layer 131.

(First and Second Underlayers)

The first underlayer 132A contains Co and O having a face-centered cubic lattice structure, and has a column (columnar crystal) structure. In the first underlayer 132A containing Co and O, substantially similar effect (function) to that of the second underlayer 132B containing Ru can be obtained. The concentration ratio of the average atomic concentration of O to the average atomic concentration of Co ((average atomic concentration of O)/(average atomic concentration of Co)) is 1 or more. When the concentration ratio is 1 or more, the effect obtained by providing the first underlayer 132A is improved, and a better SNR can be obtained.

The column structure is preferably inclined from the viewpoint of improving the SNR. The direction of the inclination is preferably the longitudinal direction of the long magnetic recording medium 130. The reason why the longitudinal direction is preferable is as follows. The magnetic recording medium 130 according to the present embodiment is a so-called magnetic recording medium for linear recording, and a recording track is parallel to the longitudinal direction of the magnetic recording medium 130. Furthermore, the magnetic recording medium 130 according to the present embodiment is also a so-called perpendicular magnetic recording medium, and from the viewpoint of recording characteristics, it is preferable that the crystal orientation axis of the magnetic layer 115 be in the perpendicular direction. However, there is a case where the crystal orientation axis of the magnetic layer 115 is inclined due to the influence of the inclination of the column structure of the first underlayer 132A. In the magnetic recording medium 130 for linear recording, due to the relationship between the head magnetic field at the time of recording, the configuration in which the crystal orientation axis of the magnetic layer 115 is inclined in the longitudinal direction of the magnetic recording medium 130 can reduce the influence of inclination of the crystal orientation axis on the recording characteristics, as compared with the configuration in which the crystal orientation axis of the magnetic layer 115 is inclined in the width direction of the magnetic recording medium 130. In order to incline the crystal orientation axis of the magnetic layer 115 in the longitudinal direction of the magnetic recording medium 130, it is preferable to set the inclination direction of the column structure of the first underlayer 132A as the longitudinal direction of the magnetic recording medium 130 as described above.

The inclination angle of the column structure is preferably more than 0° and 60° or less. When the inclination angle is in a range of more than 0° and 60° or less, the change in the tip shape of the column included in the first underlayer 132A is large and the column has a substantially triangular shape, so that the effect of the granular structure is enhanced, noise is reduced, and the SNR tends to be improved. On the other hand, when the inclination angle exceeds 60°, the change in the tip shape of the column included in the first underlayer 132A is small, and the column hardly has a substantially triangular shape, so that the low noise effect tends to be weakened.

The average particle diameter of the column structure is 3 nm or more and 13 nm or less. When the average particle diameter is less than 3 nm, the average particle diameter of the column structure included in the magnetic layer 115 becomes small, and thus the ability of the current magnetic material to hold recording may be deteriorated. On the other hand, when the average particle diameter is 13 nm or less, noise can be suppressed, and a better SNR can be obtained.

The average thickness of the first underlayer 132A is preferably 10 nm or more and 150 nm or less. When the average thickness of the first underlayer 132A is 10 nm or more, the (111) orientation of the face-centered cubic lattice structure of the first underlayer 132A is improved, and a better SNR can be obtained. On the other hand, when the average thickness of the first underlayer 132A is 150 nm or less, it is possible to suppress an increase in the particle diameter of the column. Therefore, noise can be suppressed, and a better SNR can be obtained. Note that the average thickness of the first underlayer 132A is obtained in a manner similar to the magnetic layer 13 in the first embodiment. However, the magnification of the TEM image is appropriately adjusted according to the thickness of the first underlayer 132A.

The second underlayer 132B preferably has a crystal structure similar to that of the magnetic layer 115. In a case where the magnetic layer 115 contains a Co-based alloy, it is preferable that the second underlayer 132B contain a material having a hexagonal close-packed (hcp) structure similar to that of the Co-based alloy, and the c-axis of the structure be oriented in a direction perpendicular to the film surface (that is, the film thickness direction). This is because the orientation of the magnetic layer 115 can be enhanced, and the lattice constant matching between the second underlayer 132B and the magnetic layer 115 can be made relatively good. As the material having the hexagonal close-packed structure, a material containing Ru is preferably used, and specifically, Ru single substance or a Ru alloy is preferable. Examples of the Ru alloy include Ru alloy oxides such as Ru—SiO₂, Ru—TiO₂, and Ru—ZrO₂.

The average thickness of the second underlayer 132B may be thinner than the underlayer (for example, an underlayer containing Ru) in a general magnetic recording medium, and can be, for example, 1 nm or more and 5 nm or less. Since the seed layer 131 and the first underlayer 132A having the configurations described above are provided under the second underlayer 132B, a good SNR can be obtained even when the average thickness of the second underlayer 132B is thin as described above. Note that the average thickness of the second underlayer 132B is obtained in a manner similar to the magnetic layer 13 in the first embodiment. However, the magnification of the TEM image is appropriately adjusted according to the thickness of the second underlayer 132B.

### 5. One Embodiment of Magnetic Recording Cartridge According to Present Technology

[Configuration of Cartridge]

The present technology also provides a magnetic recording cartridge (also referred to as a tape cartridge) including the magnetic recording medium according to the present technology. In the magnetic recording cartridge, the magnetic recording medium may be wound around a reel, for example. The magnetic recording cartridge may include: for example, a communication part that communicates with a recording and reproducing apparatus; a storage part; and a control part that stores information received from the recording and reproducing apparatus via the communication part in the storage part, and reads the information from the storage part in response to a request from the recording and reproducing apparatus and transmits the information to the recording and reproducing apparatus via the communication part. The information can include adjustment information for adjusting a tension applied to the magnetic recording medium in a longitudinal direction thereof.

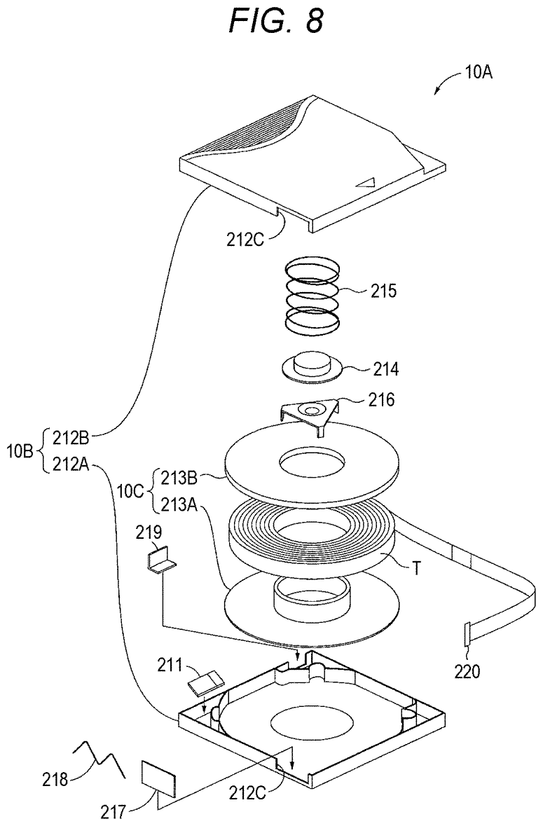

An example of the configuration of the magnetic recording cartridge 10A including a magnetic recording medium T having the configuration described above will be described with reference to FIG. 8.

FIG. 8 is an exploded perspective view illustrating an example of the configuration of the magnetic recording cartridge 10A. The magnetic recording cartridge 10A is a magnetic recording cartridge conforming to the linear tape-open (LTO) standard, and includes, inside a cartridge case 10B including a lower shell 212A and an upper shell 212B, the reel 10C around which the magnetic tape (tape-shaped magnetic recording medium) T is wound; a reel lock 214 and a reel spring 215 for locking rotation of the reel 10C; a spider 216 for unlocking the reel 10C; a slide door 217 for opening and closing a tape outlet 212C provided in the cartridge case 10B across the lower shell 212A and the upper shell 212B; a door spring 218 for biasing the slide door 217 to a closed position of the tape outlet 212C; a write protect 219 for preventing erroneous erasure; and a cartridge memory 211. The reel 10C has a substantially disk shape having an opening at the center, and includes a reel hub 213A and a flange 213B containing a hard material such as plastic. A reader pin 220 is provided at one end of the magnetic tape T.

The cartridge memory 211 is provided in the vicinity of one corner of the magnetic recording cartridge 10A. In a state where the magnetic recording cartridge 10A is loaded into a recording and reproducing apparatus 80, the cartridge memory 211 faces a reader/writer (not illustrated) of the recording and reproducing apparatus 80. The cartridge memory 211 communicates with the recording and reproducing apparatus 30, specifically, the reader/writer (not illustrated) conforming to a wireless communication standard based on the LTO standard.

[Configuration of Cartridge Memory]

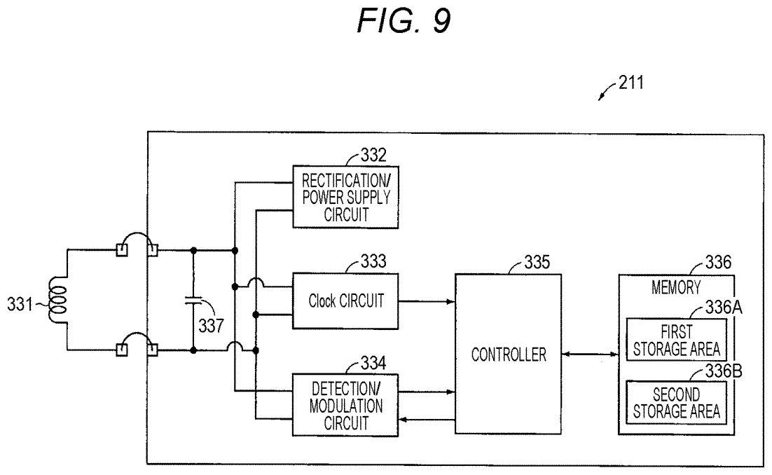

An example of the configuration of the cartridge memory 211 will be described with reference to FIG. 9.

FIG. 9 is a block diagram illustrating an example of the configuration of the cartridge memory 211. The cartridge memory 211 includes: an antenna coil (communication part) 331 that communicates with a reader/writer (not illustrated) according to a prescribed communication standard; a rectification/power supply circuit 332 that generates and rectifies a power by using an induced electromotive force from a radio wave received by the antenna coil 331; a clock circuit 333 that generates a clock by using the induced electromotive force similarly from the radio wave received by the antenna coil 331; a detection/modulation circuit 334 that detects the radio wave received by the antenna coil 331 and modulates a signal transmitted by the antenna coil 331; a controller (control part) 335 including a logic circuit or the like for determining a command and data from a digital signal extracted from the detection/modulation circuit 334 and processing the command and data; and a memory (storage part) 336 that stores information. Furthermore, the cartridge memory 211 includes a capacitor 337 connected in parallel to the antenna coil 331, and a resonance circuit is configured by the antenna coil 331 and the capacitor 337.

The memory 336 stores information and the like associated with the magnetic recording cartridge 10A. The memory 336 is a non-volatile memory (NVM). The storage capacity of the memory 336 is preferably about 32 KB or more. For example, in a case where the magnetic recording cartridge 10A conforms to the next generation or later LTO format standard, the memory 336 has a storage capacity of about 32 KB.

The memory 336 has a first storage area 336A and a second storage area 336B. The first storage area 336A corresponds to a storage area of a cartridge memory of the LTO standard prior to LTO 8 (hereinafter, referred to as a “conventional cartridge memory”), and is an area for storing information conforming to the LTO standard prior to LTO 8. The information conforming to the LTO standard prior to LTO 8 is, for example, production information (for example, a unique number of the magnetic recording cartridge 10A, or the like), a use history (for example, the number of times of tape withdrawal (thread count), or the like), or the like.

The second storage area 336B corresponds to an extended storage area with respect to a storage area of the conventional cartridge memory. The second storage area 336B is an area for storing additional information. Here, the additional information means information associated with the magnetic recording cartridge 10A that is not specified in the LTO standard prior to LTO 8. Examples of the additional information include, but are not limited to, tension adjustment information, management ledger data, index information, or thumbnail information of a moving image stored on the magnetic tape T, and the like. The tension adjustment information includes a distance between adjacent servo bands (a distance between servo patterns recorded in adjacent servo bands) at the time of data recording on the magnetic tape T. The distance between adjacent servo bands is an example of width-related information associated with the width of the magnetic tape T. Details of the distance between the servo bands will be described later. In the following description, the information stored in the first storage area 336A may be referred to as “first information”, and the information stored in the second storage area 336B may be referred to as “second information”.

The memory 336 may have a plurality of banks. In this case, some of the plurality of banks may constitute the first storage area 336A, and the remaining banks may constitute the second storage area 336B. Specifically, for example, in a case where the magnetic recording cartridge 10A conforms to the next generation or later LTO format standard, the memory 336 may include two banks having a storage capacity of about 16 KB, one of the two banks may constitute the first storage area 336A, and the other bank may constitute the second storage area 336B.

The antenna coil 331 induces an induced voltage by electromagnetic induction. The controller 335 communicates with the recording and reproducing apparatus 80 according to a prescribed communication standard via the antenna coil 331. Specifically, for example, mutual authentication, command transmission/reception, data exchange, and the like are performed.

The controller 335 stores the information received from the recording and reproducing apparatus 80 via the antenna coil 331 in the memory 336. In response to a request from the recording and reproducing apparatus 80, the controller 335 reads information from the memory 336 and transmits the information to the recording and reproducing apparatus 80 via the antenna coil 331.

### 6. Modification Example of Magnetic Recording Cartridge According to Present Technology

[Configuration of Cartridge]

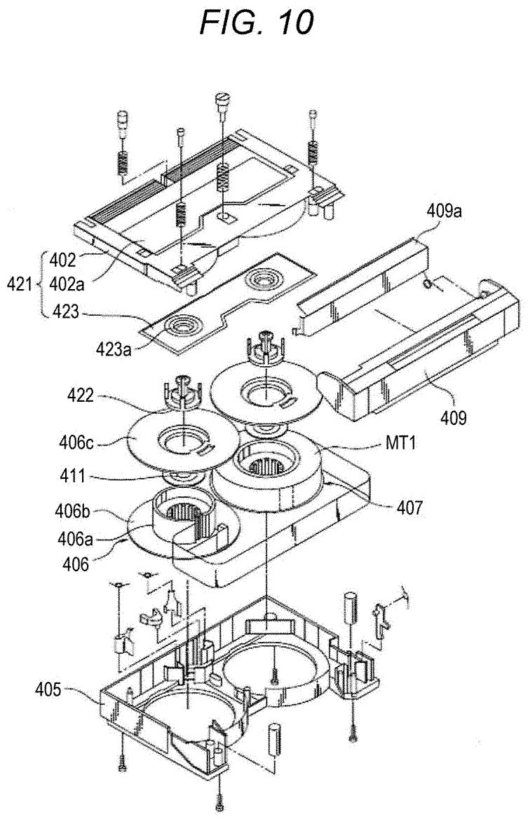

In one embodiment of the magnetic recording cartridge described above, a case where the magnetic tape cartridge is a one-reel type cartridge has been described, but the magnetic recording cartridge of the present technology may be a two-reel type cartridge. That is, the magnetic recording cartridge of the present technology may have one or a plurality of (for example, two) reels around which the magnetic tape is wound. Hereinafter, an example of the magnetic recording cartridge having two reels according to the present technology will be described with reference to FIG. 10.

FIG. 10 is an exploded perspective view illustrating an example of the configuration of a two-reel type cartridge 421. The cartridge 421 includes: an upper half 402 containing a synthetic resin; a transparent window member 423 fitted and fixed to a window part 402a opening in the upper surface of the upper half 402; reel holders 422 fixed to an inner side of the upper half 402 and preventing uplift of reels 406 and 407; a lower half 405 corresponding to the upper half 402; the reels 406 and 407 stored in a space formed by combining the upper half 402 and the lower half 405; a magnetic tape MT1 wound around the reels 406 and 407; a front lid 409 closing a front side opening formed by combining the upper half 402 and the lower half 405; and a back lid 409A protecting the magnetic tape MT1 exposed to the front side opening.

The reel 406 includes: a lower flange 406b having, in a central portion thereof, a cylindrical hub part 406a around which the magnetic tape MT1 is wound; an upper flange 406c having substantially the same size as the lower flange 406b; and a reel plate 411 sandwiched between the hub part 406a and the upper flange 406c. The reel 407 has a configuration similar to that of the reel 406.

The window member 423 is provided with attachment holes 423a for assembling the reel holders 422 as a reel holding means for preventing uplift of the reels, the attachment holes 423a being provided at positions corresponding to the reels 406 and 407, respectively. The magnetic tape MT1 is similar to the magnetic tape T in the first embodiment.

The present technology can also adopt the following configurations.

[1] A magnetic recording medium having a tape shape, the magnetic recording medium including:
a magnetic layer;
a nonmagnetic layer;
a base layer; and
a back layer in this order,
in which the magnetic layer and the nonmagnetic layer are in contact with each other,
the nonmagnetic layer and the base layer are in contact with each other,
an average thickness of the magnetic recording medium is 5.74 μm or less,
a Young's modulus in an MD direction (longitudinal direction) of the base layer is 5.9 GPa or less, and
a water vapor transmission rate of the magnetic recording medium, measured according to a Lyssy method, is 2.93 g/m²·day or less.

[2]

The magnetic recording medium according to [1], in which the water vapor transmission rate is 2.0 g/m²·day or less.

[3]

The magnetic recording medium according to [1], in which the water vapor transmission rate is 1.84 g/m²·day or less.

[4]

The magnetic recording medium according to any one of [1] to [3], in which a water vapor transmission rate of the base layer, measured according to a Lyssy method, is 7.57 g/m²·day or less.

[5]

The magnetic recording medium according to any one of [1] to [3], in which a water vapor transmission rate of the base layer is 4.00 g/m²·day or less.

[6]

The magnetic recording medium according to any one of [1] to [3], in which a water vapor transmission rate of the base layer is 3.00 g/m²·day or less.

[7]

The magnetic recording medium according to any one of [1] to [6], in which a water vapor transmission rate of the base layer is 2.19 g/m²·day or less.

[8]

The magnetic recording medium according to any one of [1] to [7], in which the Young's modulus in an MD direction (longitudinal direction) of the base layer is 5.3 GPa or less.

[9]

The magnetic recording medium according to any one of [1] to [8], in which the average thickness of the magnetic recording medium is 5.60 μm or less.

[10]

The magnetic recording medium according to any one of [1] to [8], in which the average thickness of the magnetic recording medium is 5.30 μm or less.

[11]

The magnetic recording medium according to any one of [1] to [10], in which a thickness of the nonmagnetic layer is 1.2 μm or less.

[12]

The magnetic recording medium according to any one of [1] to [11], in which a thickness of the base layer is 4.5 μm or less.

[13]

The magnetic recording medium according to any one of [1] to [12], in which a thickness of the back layer is 0.6 μm or less.

[14]

The magnetic recording medium according to any one of [1] to [13], in which a humidity expansion coefficient β at a temperature of 10° C. is 6.5 ppm/% RH or less.

[15]

The magnetic recording medium according to any one of [1] to [14], in which the magnetic layer contains magnetic powder.

[16]

The magnetic recording medium according to any one of [1] to [14], in which the magnetic layer and the nonmagnetic layer are vacuum thin films.

[17]

A magnetic recording cartridge, in which the magnetic recording medium according to any one of [1] to [16] is accommodated in a case, and the magnetic recording medium is wound around a reel.

### 7. Examples

Hereinafter, the present technology will be specifically described with reference to examples, but the present technology is not limited to only these examples.

In the following examples and comparative examples, the water vapor transmission rate of the magnetic tape, the Young's modulus of the magnetic tape, the thickness t_{T} of the magnetic tape, the thickness of the nonmagnetic layer (underlayer), the thickness of the base layer, the thickness of the back layer, the thickness tₘ of the magnetic layer, and the humidity expansion coefficient β are values obtained by the measurement methods described in the first embodiment.

### Example 1

(Process of Preparing Coating Material for Forming Magnetic Layer)

A coating material for forming a magnetic layer was prepared as follows. First, a first composition having the following formulation was kneaded with an extruder. Next, the kneaded first composition and a second composition having the following formulation were placed in a stirring tank equipped with a disper, and premixing was performed. Subsequently, mixing was further performed with a sand mill, and a filter treatment was performed to prepare a coating material for forming a magnetic layer.

(First Composition)

Magnetic powder (hexagonal ferrite having M-type structure, composition: Ba-ferrite, average particle volume: 1,600 nm3): 100 parts by mass

Vinyl chloride-based resin (cyclohexanone solution: mass %): 60 parts by mass

(degree of polymerization: 300, Mn=10,000, OSO₃K (0.07 mmol/g) and secondary OH (0.3 mmol/g) are contained as polar groups)

Aluminum oxide powder: 5 parts by mass

(α-Al₂O₃, average particle diameter: 0.2 μm)

Carbon black: 2 parts by mass

(manufactured by Tokai Carbon Co., Ltd., trade name: SEAST TA)

(Second Composition)

Vinyl chloride-based resin: 1.1 parts by mass

(resin solution: resin content: 30 mass %, cyclohexanone: 70 mass %)

n-Butyl stearate: 2 parts by mass

Methyl ethyl ketone: 121.3 parts by mass

Toluene: 121.3 parts by mass

Cyclohexanone: 60.7 parts by mass

Finally, 2 parts by mass of polyisocyanate (trade name: CORONATE L, manufactured by Nippon Polyurethane Industry Co., Ltd.) and 2 parts by mass of myristic acid were added as curing agents to the coating material for forming a magnetic layer, the coating material being prepared as described above.

(Process of Preparing Coating Material for Forming Underlayer)

A coating material for forming an underlayer was prepared as follows. First, a third composition having the following formulation was kneaded with an extruder. Next, the kneaded third composition and a fourth composition having the following formulation were placed in a stirring tank equipped with a disper, and premixing was performed. Subsequently, mixing was further performed with a sand mill, and a filter treatment was performed to prepare a coating material for forming an underlayer.

(Third Composition)

Needle-shaped iron oxide powder: 100 parts by mass

(α-Fe₂O₃, average long axis length: 0.15 μm)

Vinyl chloride-based resin: 55.6 parts by mass

(resin solution: resin content: 30 mass %, cyclohexanone: 70 mass %)

Carbon black: 10 parts by mass

(Average particle diameter: 20 nm)

(Fourth Composition)

Polyurethane-based resin UR 8200 (manufactured by Toyobo Co., Ltd.): 18.5 parts by mass

n-Butyl stearate: 2 parts by mass

Methyl ethyl ketone: 108.2 parts by mass

Toluene: 108.2 parts by mass

Cyclohexanone: 18.5 parts by mass

Finally, 2 parts by mass of polyisocyanate (trade name: CORONATE L, manufactured by Tosoh Corporation) and 2 parts by mass of myristic acid were added as curing agents to the coating material for forming an underlayer, the coating material being prepared as described above.

(Process of Preparing Coating Material for Forming Back Layer)

A coating material for forming a back layer was prepared as follows. The following raw materials were mixed in a stirring tank equipped with a disper and subjected to a filter treatment to prepare a coating material for forming a back layer.

Carbon black (manufactured by Asahi Carbon Co., Ltd., trade name: #80): 100 parts by mass

Polyester polyurethane: 100 parts by mass

(manufactured by Nippon Polyurethane Industry Co., Ltd., trade name: N-2304)

Methyl ethyl ketone: 500 parts by mass

Toluene: 400 parts by mass

Cyclohexanone: 100 parts by mass

Polyisocyanate (trade name: CORONATE L, manufactured by Tosoh Corporation): 10 parts by mass

(Film Forming Process)

A magnetic tape was prepared as described below using the coating materials prepared as described above.

First, as a support to be a base layer of the magnetic tape, a PEN film (base film) having a long shape and an average thickness of 4.0 μm was prepared. Next, the coating material for forming an underlayer was applied onto one main surface of the PEN film and dried to form an underlayer on the one main surface of the PEN film so that the average thickness of the final product was 1.25 μm. Next, the coating material for forming a magnetic layer was applied onto the underlayer and dried to form a magnetic layer on the underlayer so that the average thickness of the final product was 0.08 μm.

Subsequently, the coating material for forming a back layer was applied onto the other main surface of the PEN film on which the underlayer and the magnetic layer had been formed, and dried to form the back layer so that the average thickness of the final product was 0.58 μm. Then, the PEN film on which the underlayer, the magnetic layer, and the back layer had been formed was subjected to a curing treatment. Thereafter, calender treatment was performed to smooth the surface of the magnetic layer.

(Cutting Process)

The magnetic tape obtained as described above was cut into a width of ½ inches (12.65 mm). As a result, a magnetic tape having a long shape was obtained. In the obtained magnetic tape, the water vapor transmission rate of the magnetic tape was 1.84 g/m²·day, the humidity expansion coefficient β at a temperature of 10° C. was 3.23 ppm/% RH, the tape TD Young's modulus was 12.4 GPa, and the average thickness t_{T} of the magnetic tape was 5.74 μm.

### Example 2

A magnetic tape was obtained by the same method as in Example 1 except that, in Example 1, the thickness of the base layer was 3.60 μm, the thickness of the back layer was 0.50 μm, and the average thickness t_{T} of the magnetic tape was 5.29 μm. The water vapor transmission rate of the magnetic tape was 2.93 g/m²·day, the humidity expansion coefficient β at a temperature of 10° C. was 5.66 ppm/% RH, the tape TD Young's modulus was 8.9 GPa, and the average thickness t_{T} of the magnetic tape was 5.29 μm.

### Comparative Example 1

A magnetic tape was obtained by the same method as in Example 1 except that, in Example 1, the average thickness t_{T} of the magnetic tape was 5.65 μm. The water vapor transmission rate of the magnetic tape was 3.22 g/m²·day, the humidity expansion coefficient β at a temperature of 10° C. was 6.12 ppm/% RH, and the TD Young's modulus of the magnetic tape was 9.9 GPa.

### Comparative Example 2

A magnetic tape was obtained by the same method as in Example 1 except that, in Example 1, the thickness of the back layer was 0.50 μm and the average thickness t_{T} of the magnetic tape was 5.23 μm. The water vapor transmission rate of the magnetic tape was 6.36/m²·day, the humidity expansion coefficient β at a temperature of 10° C. was 10.12 ppm/% RH, and the TD Young's modulus of the magnetic tape was 6.77 GPa.

### Example 3

(Process of Forming SUL)

First, under the following film formation conditions, a CoZrNb layer (SUL) having an average thickness of 100 nm was formed on the surface of a long polymer film as a nonmagnetic support (base layer). Note that a PEN film was used as the polymer film.

Film forming method: DC magnetron sputtering method

Target: CoZrNb target

Gas type: Ar

Gas pressure: 0.1 Pa

(Process of Forming First Seed Layer)

Next, a TiCr layer (first seed layer) having an average thickness of 3 nm was formed on the CoZrNb layer under the following film formation conditions.

Sputtering method: DC magnetron sputtering method

Target: TiCr target

Degree of vacuum attained: 5×10⁻⁵ Pa

Gas type: Ar

Gas pressure: 0.5 Pa

(Process of Forming Second Seed Layer)

Next, a NiW layer (second seed layer) having an average thickness of 10 nm was formed on the TiCr layer under the following film formation conditions.

Sputtering method: DC magnetron sputtering method

Target: NiW target

Degree of vacuum attained: 5×10⁻⁵ Pa

Gas type: Ar

Gas pressure: 0.5 Pa

(Process of Forming First Underlayer)

Next, a Ru layer (first underlayer) having an average thickness of 10 nm was formed on the NiW layer under the following film formation conditions.

Sputtering method: DC magnetron sputtering method

Target: Ru target

Gas type: Ar

Gas pressure: 0.5 Pa

(Process of Forming Second Underlayer)

Next, a Ru layer (second underlayer) having an average thickness of 20 nm was formed on the Ru layer under the following film formation conditions.

Sputtering method: DC magnetron sputtering method

Target: Ru target

Gas type: Ar

Gas pressure: 1.5 Pa

(Process of Forming Magnetic Layer)

Next, a (CoCrPt)—(SiO₂) layer (magnetic layer) having an average thickness of 14 nm was formed on the Ru layer under the following film formation conditions.

Film forming method: DC magnetron sputtering method

Target: (CoCrPt)—(SiO₂) target

Gas type: Ar

Gas pressure: 1.5 Pa

(Process of Forming Protective Layer)

Next, a carbon layer (protective layer) having an average thickness of 5 nm was formed on the magnetic layer under the following film formation conditions.

Film forming method: DC magnetron sputtering method

Target: carbon target

Gas type: Ar

Gas pressure: 1.0 Pa

(Process of Forming Lubricating Layer)

Next, a lubricant was applied onto the protective layer to form a lubricating layer. Note that the total thickness of the sputtered films on the base layer was 45 nm.

(Process of Forming Back Layer)

Next, the coating material for forming a back layer was applied to the surface opposite to the magnetic layer, and dried to form a back layer having an average thickness t_{b} of 0.3 μm. As a result, a magnetic tape having an average thickness t_{T} of 4.0 μm was obtained.

(Cutting Process)

The magnetic tape obtained as described above was cut into a width of ½ inches (12.65 mm).

In the magnetic tape obtained as described above, the water vapor transmission rate of the magnetic tape was 0.06 g/m²·day, and the water vapor transmission rate could be reduced by about 98% with respect to the water vapor transmission rate of 2.97 g/m²·day of a single base layer (PEN film).

Table 1 shows the configurations and evaluation results of the magnetic tapes of Examples 1 to 2 and Comparative Examples 1 to 2.

TABLE 1

| | | | | | | Characteristics |
|---|---|---|---|---|---|---|
| | Magnetic | | Base | Back | | Tape water |
| | layer | Underlayer | layer | layer | Tape | vapor |
| | Thickness | Thickness | Thickness | Thickness | thickness | transmission |
| | (μm) | (μm) | (μm) | (μm) | (μm) | rate |
| Example 1 | 0.08 | 1.25 | 4.00 | 0.58 | 5.74 | 1.84 |
| Example 2 | 0.08 | 1.25 | 3.60 | 0.50 | 5.29 | 2.93 |
| Comparative | 0.08 | 1.25 | 4.00 | 0.58 | 5.65 | 3.22 |
| Example 1 | | | | | | |
| Comparative | 0.08 | 1.25 | 4.00 | 0.50 | 5.23 | 6.36 |
| Example 2 | | | | | | |
| | Characteristics | | | | | |
| | | | | Base | Base | |
| | Base layer | Tape TD | Tape MD | layer TD | layer MD | Temperature |
| | water vapor | Young’s | Young’s | Young’s | Young’s | expansion |
| | transmission | modulus | modulus | modulus | modulus | coefficient α |
| | rate | (Gpa) | (Gpa) | (Gpa) | (Gpa) | (10% RH) |
| Example 1 | 2.19 | 12.7 | 5.9 | 12.4 | 5.3 | 7.60 |
| Example 2 | 7.57 | 8.5 | 7.4 | 7.9 | 5.9 | 8.50 |
| Comparative | 4.49 | 9.9 | 7.5 | 9.0 | 6.7 | 6.75 |
| Example 1 | | | | | | |
| Comparative | 7.61 | 7.9 | 6.1 | 6.7 | 4.7 | 10.15 |
| Example 2 | | | | | | |
| | | Characteristics | | | | |
| | | Temperature | Temperature | Humidity | Humidity | Humidity |
| | | expansion | expansion | expansion | expansion | expansion |
| | | coefficient α | coefficient α | coefficient β | coefficient β | coefficient β |
| | | (40% RH) | (80% RH) | (10° C.) | (35° C.) | (60° C.) |
| | Example 1 | 9.46 | 14.86 | 3.23 | 6.25 | 8.42 |
| | Example 2 | 7.94 | 15.69 | 5.66 | 7.99 | 10.80 |
| | Comparative | 10.28 | 14.78 | 6.12 | 8.76 | 11.87 |
| | Example 1 | | | | | |
| | Comparative | 14.46 | 14.89 | 10.12 | 11.23 | 13.50 |
| | Example 2 | | | | | |

Note that each symbol in Table 1 means the following measured values.

t_{T}: thickness of magnetic tape (unit: μm)

β: humidity expansion coefficient of magnetic tape (unit: ppm/% RH)

tₘ: average thickness of magnetic layer (unit: nm)

t_{b}: average thickness of back layer (unit: μm)

Note that the measured values in the table are values obtained by rounding off the lower digits.

[Relationship Between Water Vapor Transmission Rate and Humidity Expansion Coefficient β]

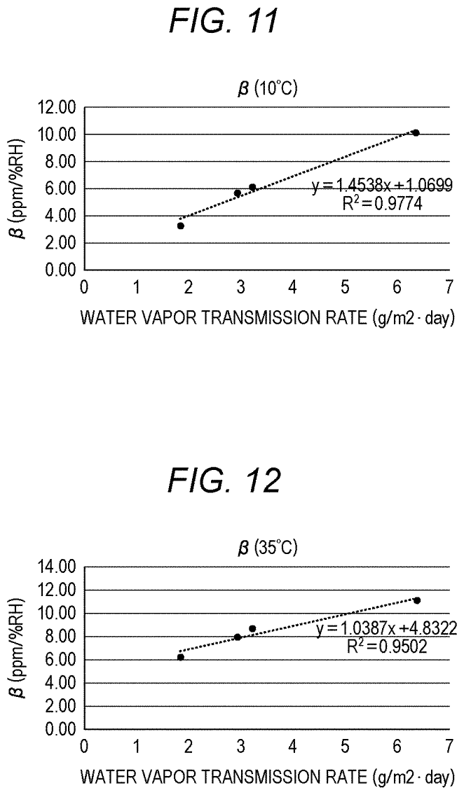

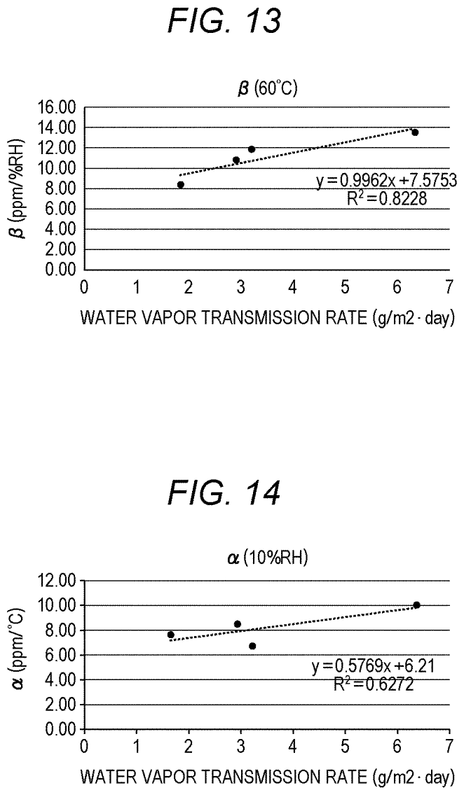

FIG. 11 shows the relationship between the water vapor transmission rate and the humidity expansion coefficient β at a temperature of 10° C. of the magnetic tape in each of Example 1, Example 2, Comparative Example 1, and Comparative Example 2 described above. Furthermore, FIG. 12 shows the relationship between the water vapor transmission rate and the humidity expansion coefficient β at a temperature of 35° C. of the magnetic tape in each of Example 1, Example 2, Comparative Example 1, and Comparative Example 2. Moreover, FIG. 13 shows the relationship between the water vapor transmission rate and the humidity expansion coefficient β at a temperature of 60° C. of the magnetic tape in each of Example 1, Example 2, Comparative Example 1, and Comparative Example 2.

[Relationship Between Water Vapor Transmission Rate and Temperature Expansion Coefficient α]

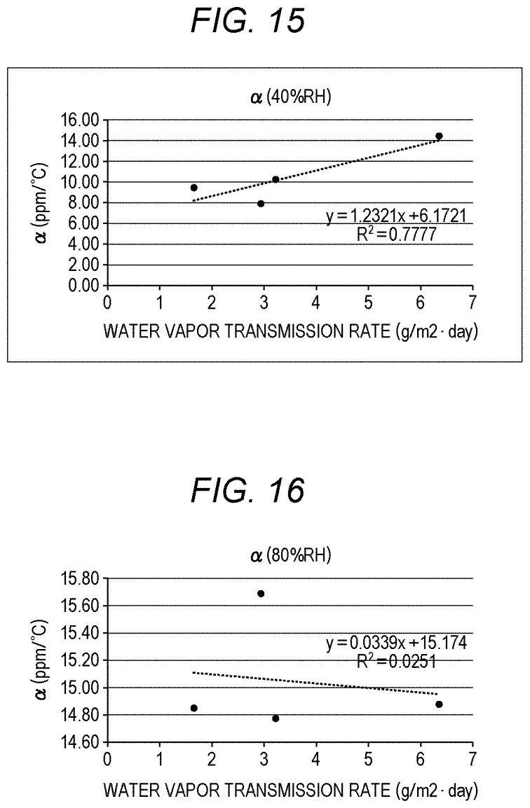

FIG. 14 shows the relationship between the water vapor transmission rate and the temperature expansion coefficient α at a relative humidity of 10% of the magnetic tape in each of Example 1, Example 2, Comparative Example 1, and Comparative Example 2 described above. Furthermore, FIG. 15 shows the relationship between the water vapor transmission rate and the temperature expansion coefficient α at a relative humidity of 40% of the magnetic tape in each of Example 1, Example 2, Comparative Example 1, and Comparative Example 2. Moreover, FIG. 15 shows the relationship between the water vapor transmission rate and the temperature expansion coefficient α at a relative humidity of 80% of the magnetic tape in each of Example 1, Example 2, Comparative Example 1, and Comparative Example 2.

From the results shown in Table 1, the following can be seen.

In each of the magnetic tapes of Examples 1 to 2, the water vapor transmission rate of the magnetic tape was 3.2 g/m²·day or less, the humidity expansion coefficient β at 10° C. was 6.00 ppm/% RH or less, and the dimensional stability in the width direction was excellent.

From the results shown in FIGS. 8 to 10, it can be seen that R² is 0.8 or more in any temperature environment, and the water vapor transmission rate and the humidity expansion coefficient β of the magnetic tape have a correlation. That is, it is found that as the water vapor transmission rate decreases, the humidity expansion coefficient contributing to the dimensional stability decreases, and the dimensional stability is further improved.

Although the embodiments and examples of the present technology have been specifically described above, the present technology is not limited to the embodiments and examples described above, and various modifications based on the technical idea of the present technology are possible.

For example, the configurations, methods, processes, shapes, materials, numerical values, and the like described in the embodiments and examples described above are merely examples, and different configurations, methods, processes, shapes, materials, numerical values, and the like may be used as necessary. Furthermore, the chemical formulas of the compounds and the like are representative, and are not limited to the described valences and the like as long as they are common names of the same compounds.

Furthermore, the configurations, methods, processes, shapes, materials, numerical values, and the like of the embodiments and examples described above can be combined with each other without departing from the gist of the present technology.

Furthermore, in the present specification, a numerical range indicated by using “to” indicates a range including numerical values described before and after “to” as a minimum value and a maximum value, respectively. In the numerical range described in stages in the present specification, the upper limit or the lower limit of the numerical range of a certain stage may be replaced with the upper limit or the lower limit of the numerical range of another stage. The materials exemplified in the present specification can be used alone or in combination of two or more unless otherwise specified.

### REFERENCE SIGNS LIST

10 Magnetic recording medium
11 Base layer
12 Underlayer
13 Magnetic layer
14 Back layer

1. A magnetic recording medium having a tape shape, the magnetic recording medium comprising:
a magnetic layer;
a nonmagnetic layer;
a base layer; and
a back layer in this order,
wherein the magnetic layer and the nonmagnetic layer are in contact with each other,
the nonmagnetic layer and the base layer are in contact with each other,
an average thickness of the magnetic recording medium is 5.74 μm or less,
a Young's modulus in an MD direction (longitudinal direction) of the base layer is 5.9 GPa or less, and
a water vapor transmission rate of the magnetic recording medium, measured according to a Lyssy method, is 2.93 g/m²·day or less.

2. The magnetic recording medium according to claim 1, wherein the water vapor transmission rate is 2.00 g/m²·day or less.

3. The magnetic recording medium according to claim 1, wherein the water vapor transmission rate is 1.84 g/m²·day or less.

4. The magnetic recording medium according to claim 1, wherein a water vapor transmission rate of the base layer, measured according to a Lyssy method, is 7.57 g/m²·day or less.

5. The magnetic recording medium according to claim 1, wherein a water vapor transmission rate of the base layer is 4.00 g/m²·day or less.

6. The magnetic recording medium according to claim 1, wherein a water vapor transmission rate of the base layer is 3.00 g/m²·day or less.

7. The magnetic recording medium according to claim 1, wherein a water vapor transmission rate of the base layer is 2.19 g/m²·day or less.

8. The magnetic recording medium according to claim 1, wherein the Young's modulus in an MD direction (longitudinal direction) of the base layer is 5.3 GPa or less.

9. The magnetic recording medium according to claim 1, wherein the average thickness of the magnetic recording medium is 5.60 μm or less.

10. The magnetic recording medium according to claim 1, wherein the average thickness of the magnetic recording medium is 5.30 μm or less.

11. The magnetic recording medium according to claim 1, wherein a thickness of the nonmagnetic layer is 1.2 μm or less.

12. The magnetic recording medium according to claim 1, wherein a thickness of the base layer is 4.5 μm or less.

13. The magnetic recording medium according to claim 1, wherein a thickness of the back layer is 0.6 μm or less.

14. The magnetic recording medium according to claim 1, wherein a humidity expansion coefficient β at a temperature of 10° C. is 6.5 ppm/% RH or less.

15. The magnetic recording medium according to claim 1, wherein the magnetic layer contains magnetic powder.

16. The magnetic recording medium according to claim 1, wherein the magnetic layer and the nonmagnetic layer are vacuum thin films.

17. A magnetic recording cartridge, wherein the magnetic recording medium according to claim 1 is accommodated in a case, and the magnetic recording medium is wound around a reel.
